(19) United States
(12) Patent Application Publication
(10) Pub. No.: US 2018/0352428 A1
(43) Pub. Date: Dec. 6, 2018

(54) REPORTING SERVICE HYBRID WEB/MOBILE APPLICATION PLATFORM SYSTEM AND METHODS

(71) Applicant: Report It, LLC, Lancaster, PA (US)

(72) Inventors: Raymond Sobieski, Lancaster, PA (US); Anthony Lavelle, Oakdale, NY (US)

(21) Appl. No.: 15/780,130

(22) PCT Filed: Dec. 7, 2016
(86) PCT No.: PCT/US16/65348

§ 371 Date: May 30, 2018

Related U.S. Application Data
(60) Provisional application No. 62/263,939, filed on Dec. 7, 2015.

(51) Int. Cl. H04W 12/02; G06F 17/30; H04L 29/06; G06F 21/62

(52) U.S. Cl. CPC H04W 12/02; G06F 17/30241; G06F 21/6254; H04L 63/0421; G06F 17/3087

(57) ABSTRACT

Methods and systems for sending confidential anonymous location- or organization-specific reports from a mobile device based application or internet based website to a server platform are described. In various illustrative embodiments, the reports are generated by a user of a mobile device application that utilizes location information from the mobile device to assist in locating a participating organization and present the user a location specific report questionnaire. After completing the report questionnaire, the user submits reports via a communications network whereby reports are relayed to a server. Once the reports are received at the server, they are entered into a database and a new report notification is subsequently relayed to designated recipients of the participating organizations based upon selected routing protocols. The participating organization can then utilize the information from the reports to address user concerns or issues and/or amend practices based upon the information from submitted reports.

### BACKGROUND

Mobile device users are increasingly technology savvy and are capable of locating information on businesses and organizations easily and quickly. These technology savvy users are uniquely positioned to readily share real-time information on a multitude of topics including his or her consumer, community or employment interactions and experiences. Mobile device user data, observations and opinions have become more and more important as technology advances, the prevalence of smart mobile devices increases and improvements in network connectivity provide users the ability to easily communicate this important and relevant information immediately in real-time and publicly via the internet and social media.

When a consumer shares his or her opinion of a business, over social media for example, it is more typically for negative reasons, and unless a business is directly connected into the user's social media feed, the businesses are neither aware of the issue nor able to address the consumer's concerns or issues to have an opportunity to prevent other potential consumers from developing a negative impression based upon the consumer's experience. The lack of incident-specific data also prevents businesses from positively responding to and resolving the initial consumer's concern or issue.

Many law enforcement agencies encourage citizens to communicate suspicious activities or concerns via programs such as “see something, say something” or toll free tip lines. Mobile device users are uniquely qualified to assist in these efforts by having the ability to relay important data instantly, but may choose not to participate because of the time and effort involved in communicating the data by calling various agency specific 800 numbers or the concern over a lack of anonymity.

Individual citizens may often see something that they would like to communicate to a property owner, but are not aware of the property owners name, phone number or e-mail address. For example, while out walking his or her dog in the afternoon a citizen notices a neighbor's garage door is open. Knowing this neighbor works outside the home this seems unusual. The concerned citizen does not feel this warrants a call to 911, but would like to communicate this to the property owner; however he does not have the proper contact information.

Employees of a business or organization are uniquely qualified to provide management and business owner's important information that can have a direct impact on operations, morale and financial performance. Current methods of communicating such information (e.g., a suggestion box) are inefficient and there is no assurance that the information will be elevated to the appropriate management and direct communication of sensitive information may be impractical due to fears of retribution. Large organizations may have employee hotlines, but smaller organizations may not be able to afford this expense. Most employees now have access to a mobile device or the Internet and having the ability to provide real-time information directly to management would be beneficial to all.

Businesses, organizations, public agencies and individuals that provide an alternate means for the mobile device user to address his or her concerns or issues and communicate relevant information in real-time can take advantage of the input from these users by providing a platform where the user can readily access and upload information with the trust that the concern will be reviewed and addressed by a party with an invested interest. Additionally, the information provided by the user can be submitted anonymously and in a non-confrontational manner while still permitting the recipient(s) to become aware of the issue. Further, users of a mobile device can address his or her issues or concerns via a mobile device application immediately and in real-time and where the receiving party can utilize the information to promote relevant and consistent communication with the user. For example, being more connected to a consumer would enable a business to advance a more personal experience with consumers and in return, with an unprecedented quality of engagement, develop positive lasting relationships with those consumers.

Consumers may be able to post their experiences on social media outlets such as Twitter™, Instagram™, or Facebook™, or consumers may their comments reviewing businesses on websites such as Yelp™, whereby the business may have an opportunity to submit a rebuttal. However, none of the aforementioned social media sites permits the business or organization to be provided with a real-time alert that there is an issue, location specific data to evaluate the issue and a means to directly address the consumers concerns in real time. Further, none of the aforementioned social media sites permits for what both the consumer and business or organization wants out of the situation, which is, if possible, to resolve the issue to the satisfaction of both parties and create a positive experience for the consumer from a potentially negative one.

From the foregoing, it is appreciated that there exists a need for applications and methods that are aimed to ameliorate the shortcomings of existing practices.

### SUMMARY OF THE INVENTION

Illustrative embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents, and alternative constructions that fall within the spirit and scope of the invention as expressed in the claims.

The present invention can provide for a hybrid web/mobile application (“app”) software program based platform system and methods allowing for the anonymous, confidential, and non-confrontational reporting of comments, concerns, location data (e.g., via GPS coordinates), information, and questions directly with companies, organizations or individuals and his or her management (recipient(s)) either in real-time from a mobile device or at a later time via the internet using the website via a communications network. One illustrative embodiment is a mobile device application software program based platform system that provides for the anonymous, confidential reporting of comments, concerns, location data (e.g., via GPS coordinates), information, media (photo and video) and questions (collectively the “report”) to the recipient(s) wherein the mobile application software program platform system includes a computer server; the display of a generated questionnaire and free text comments section for a selected location-specific participating recipient(s); the ability to attach a photo or video; the transmission of the report to the server; the notification to the participating recipient(s) of the receipt of the report and its transmission to the corresponding participating recipient(s); wherein the participating recipient(s) can have the option to immediately and in real-time retrieve the report and have the option to immediately respond to the application user's comment or concern either with a responsive action or by transmitting a responsive communication back through the server and to the application on the user's mobile device.

Another illustrative embodiment is a computer server web-based software program platform system that provides for the anonymous, confidential reporting of comments, concerns, location data (e.g., via GPS coordinates), information, media, and questions (collectively the “report”) to companies, organizations or individuals and his or her management (recipient(s)) wherein the computer server web based software platform system includes a computer server; a web page providing the display of a generated questionnaire and free text comments section for a selected location specific participating recipient(s); the transmission of the completed report to the server; the notification to the participating recipient(s) of the receipt of a submitted report and its transmission to the corresponding participating recipient(s); wherein the participating recipient(s) can have the option to immediately and in real-time retrieve the report and have the option to immediately respond to the application user's comment or concern either with a responsive action or by transmitting a responsive communication back through the server and to the web page on the user's interne connected computer, tablet, mobile device or similar device.

Yet another illustrative embodiment is a mobile device application software program based method that provides for the anonymous, confidential reporting of comments, concerns, location data (e.g., via GPS coordinates), information, media, and questions (collectively the “report”) to companies, organizations or individuals and his or her management (recipient(s)) wherein the mobile application software program platform system includes a computer server; the display of a generated questionnaire and free text comments section for a selected location specific participating recipient(s); the transmission of the completed questionnaire and comments to the server; the notification to the participating recipient(s) of the receipt of a submitted report and its transmission to the corresponding participating recipient(s); wherein the participating recipient(s) can have the option to immediately and in real-time retrieve the questionnaire report and have the option to immediately respond to the application user's comment or concern either with a responsive action or by transmitting a responsive communication back through the server and to the application on the user's mobile device.

These and other embodiments are described in further detail herein. Systems implementing the methods of the invention are also described.

### FURTHER ASPECTS OF THE INVENTION

Further aspects of the invention include:

Aspect 1: An apparatus adapted to transmit a location-specific or participating organization-specific questionnaire report template to a user of an electronic device, the apparatus comprising instructions stored on non-transitory machine readable media that, when executed, cause at least one server to:
anonymously receive, responsive to an authorization by the user of the electronic device, information sufficient to identify a geographic location of the electronic device;
generate, from server-accessible memory, a list of participating organizations within a geographic area, the geographic area being determined at least in part by the information received from the user relating to the geographic location of the electronic device;
transmit the list of participating organizations within the geographic area to the electronic device of the user for display on the electronic device;
anonymously receive report information from the third party user relating to at least one participating organization of the list of participating organizations;
generate, from server-accessible memory, the location-specific or participating organization-specific questionnaire report template, wherein at least some contents of the location-specific or participating organization-specific questionnaire report template are determined at least in part by the information received from the user relating to the identity of the at least one participating organization; and
transmit the location-specific or participating organization-specific questionnaire report template to the user.

Aspect 2: The apparatus of Aspect 1, the apparatus further comprising instructions stored on non-transitory machine readable media that, when executed, cause the at least one server to:
anonymously receive report information from the user relating to the at least one participating organization of the list of participating organizations in response to the location-specific or participating organization-specific questionnaire report template.

Aspect 3: The apparatus of any of Aspects 1-2, the apparatus further comprising instructions stored on non-transitory machine readable media that, when executed, cause the at least one server to:
receive feedback information from the at least one participating organization in response to the received report information; and
transmit the feedback information to the electronic device of the user.

Aspect 4: The apparatus of any of Aspects 1-3, the apparatus further comprising instructions stored on non-transitory machine readable media that, when executed, cause the at least one server to:
generate, from server-accessible memory, the list of participating organizations within the geographic area based on a geofenced area or political unit.

Aspect 5: The apparatus of Aspect 4, the apparatus further comprising instructions stored on non-transitory machine readable media that, when executed, cause the at least one server to define the geofenced area based on a custom polygon tool.

Aspect 6: The apparatus of Aspect 4, the apparatus further comprising instructions stored on non-transitory machine readable media that, when executed, cause the at least one server to define the geofenced area based on a predefined circular region.

Aspect 7: The apparatus of any of Aspects 2-6, the apparatus further comprising instructions stored on non-transitory machine readable media that, when executed, cause the at least one server to anonymously receive the report information from the user relating to the at least one participating organization, wherein in response to an instruction provided by the user, the apparatus collects weather data relating to the geographic area and includes the weather data in the report information.

Aspect 8: A method of operating at least one server, the method comprising:
anonymously receiving geolocation information from a third party user, the geolocation information being dependent on a then-current location of an electronic device owned by the third party user;
generating from server-accessible memory a list of participating organizations within a geographic area, the geographic area being determined at least in part by the geolocation information received from the electronic device of the third party user;
transmitting the list of participating organizations within the geographic area to the electronic device of the third party user for display thereon; and
anonymously receiving report information from the third party user relating to at least one participating organization of the list of participating organizations.

Aspect 9: The method of Aspect 8, further comprising, prior to the step of anonymously receiving report information from the third party user:
anonymously receiving information from the third party user relating to the identity of the at least one participating organization; and
transmitting to the third party user a location-specific or participating organization-specific questionnaire report template, wherein at least some contents of the location-specific or participating organization-specific questionnaire report template are determined at least in part by the information received from the third party user relating to the identity of the at least one participating organization.

Aspect 10: The method of any of Aspects 8-9, further comprising transmitting the received report information to the at least one participating organization.

Aspect 11: The method of Aspect 10, further comprising:
receiving feedback information from the at least one participating organization in response to the received report information; and
transmitting the feedback information to the electronic device of the third party user.

Aspect 12: The method of any of Aspects 8-11, wherein the step of anonymously receiving report information from the third party user relating to the at least one participating organization comprises receiving a photograph or video from the third party user, the photograph or video relating to the at least one participating organization.

Aspect 13: The method of any of Aspects 8-12, wherein the step of anonymously receiving report information from the third party user relating to the at least one participating organization comprises receiving a comment or question relating to the at least one participating organization.

Aspect 14: The method of any of Aspects 8-13, wherein the step of generating from server-accessible memory a list of participating organizations within a geographic area further comprises determining the geographic area based on a geofenced area or political unit.

Aspect 15: The method of Aspect 14, wherein the step of determining the geographic area based on a geofenced area or political unit comprises defining the geofenced area based on a custom polygon tool.

Aspect 16: The method of Aspect 14, wherein the step of determining the geographic area based on a geofenced area or political unit comprises defining the geofenced area based on a predefined circular region.

Aspect 17: The method of any of Aspects 8-16, wherein the step of anonymously receiving report information from the third party user relating to at least one participating organization of the list of participating organizations further comprises collecting weather data relating to the geographic area and including the weather data in the report information.

### BRIEF DESCRIPTION OF THE DRAWINGS

FIG. 1 is a block diagram of an exemplary hybrid web/mobile application (“app”) software program-based platform system in accordance with an implementation of the herein described systems and methods;

FIG. 2 is a block diagram of an exemplary networked hybrid web/mobile application (“app”) software program-based platform system and the interaction among its components in accordance with an implementation of the herein described systems and methods;

FIG. 3 depicts a mobile device with a display capability whereby the features of the application would be utilized;

FIG. 4 depicts the initial reporting service mobile application Title/Terms of Service/Acceptance and Installation screen page;

FIG. 5 depicts the primary reporting service mobile application opening title page screen to indicate the app that is opening and the status of loading of the application;

FIG. 6 depicts an example of the reporting service mobile application participating business/organization locator and selection screen to provide the user several options for locating and selecting participating businesses and organizations;

FIG. 6A depicts an example of the reporting service mobile application participating business/organization selection screen that permits the user to select the participating business or organization from one of a number of categories;

FIG. 7 depicts an example of the reporting service mobile application “Search Nearby” results screen page;

FIG. 8 depicts an example of a screen of a reporting service mobile application report questionnaire template designated for a participating business/organization;

FIG. 9 depicts an example of the reporting service mobile application report submission status screen;

FIG. 10 depicts an example of the reporting service mobile application settings screen;

FIG. 11 depicts an example of the reporting service mobile application recent reports screen;

FIG. 12, which is an option screen, depicts an example of the reporting service mobile application message chain screen;

FIG. 13 depicts an example of the reporting service mobile application response from participating organization screen;

FIG. 14 depicts an alternate embodiment of an example of the reporting service mobile application “Search Nearby” results screen page;

FIG. 15 depicts an alternate embodiment of an example of a screen of a reporting service mobile application report questionnaire template designated for a participating business/organization;

FIG. 16 depicts yet another alternate embodiment of an example of a screen of a reporting service mobile application report questionnaire template designated for a participating business/organization;

FIG. 17 depicts an example of the reporting service mobile application settings screen;

FIG. 18 depicts an alternate embodiment of an example of a screen of a reporting service mobile application report questionnaire template;

FIG. 19 depicts an example of the reporting service customer backend tool customer participating organization listing/create new customer entry screen;

FIG. 20 depicts an example of the reporting service customer participating organization backend tool enter/edit customer participating organization information screen;

FIG. 21 depicts an example of the reporting service customer participating organization backend tool customer listing/create new customer participating organization location entry screen;

FIG. 22 depicts an example of the reporting service customer participating organization backend tool enter/edit customer participating organization location main information tab screen;

FIG. 23 depicts an example of the reporting service customer participating organization backend tool enter/edit customer participating organization location address information tab screen;

FIG. 23A depicts an example of the reporting service customer participating organization backend tool enter/edit customer participating organization location search tool for searching the relevant location based on state;

FIG. 23B depicts an example of the reporting service customer participating organization backend tool enter/edit customer participating organization location search tool for searching the relevant location based on county;

FIG. 23C depicts an example of the reporting service customer participating organization backend tool enter/edit customer participating organization location search tool for searching the relevant location using a custom map-based polygon tool;

FIG. 23D depicts an example of the reporting service customer participating organization backend tool enter/edit customer participating organization location search tool for searching the relevant location using a map-based radius tool;

FIG. 24 depicts an example of the reporting service customer participating organization backend tool enter/edit customer participating organization location reporting fields information tab screen;

FIG. 25 depicts an example of the reporting service customer participating organization backend tool enter/edit customer location template information tab screen;

FIG. 26 depicts an example of the reporting service customer participating organization backend tool edit template screen;

FIG. 27 depicts an example of the reporting service customer participating organization backend tool edit response answer template screen;

FIG. 28 depicts an example of the reporting service customer participating organization backend tool report details screen with information; and

FIG. 29 depicts a continuation of an example of the reporting service customer participating organization backend tool report details screen with information.

### DETAILED DESCRIPTION

The following detailed description refers to the accompanying drawings. The same reference numbers in different drawings may identify the same or similar elements. The following detailed description does not limit the invention.

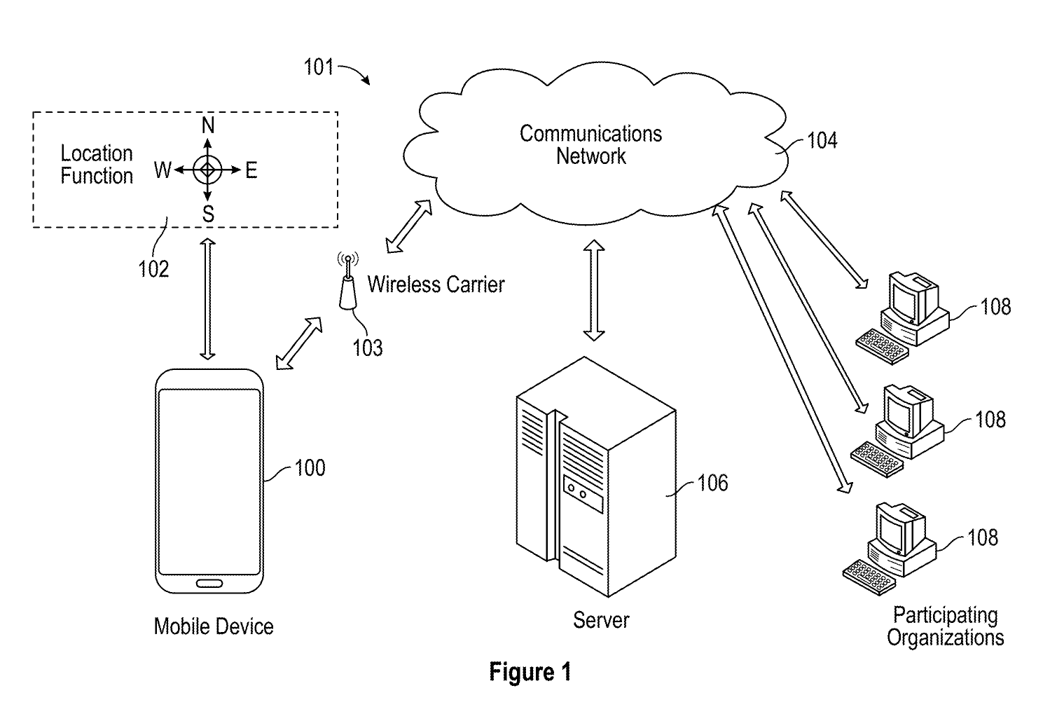

Referring now to the drawings, where like or similar elements are designated with identical reference numerals throughout the several views, and referring in particular to FIG. 1, it is a functional block diagram of a hybrid web/mobile application (“app”) software program based platform system 101 in which various illustrative embodiments of the invention can be implemented. System 101 includes communications network 104, which interconnects one or more participating organizations 108, one or more wireless carriers 103 (e.g., SPRINT, T-MOBILE, AT&T, etc.), one or more computer servers 106 and one or more mobile devices 100. In some embodiments, communications network 104 includes, but is not necessarily limited to the Internet. Participating organizations 108 include but are not limited to: public and private companies (restaurants, retail businesses, service industry businesses, etc.), nonprofit entities, healthcare institutions, financial institutions, government agencies (law enforcement, homeland security agencies, emergency services), and individuals.

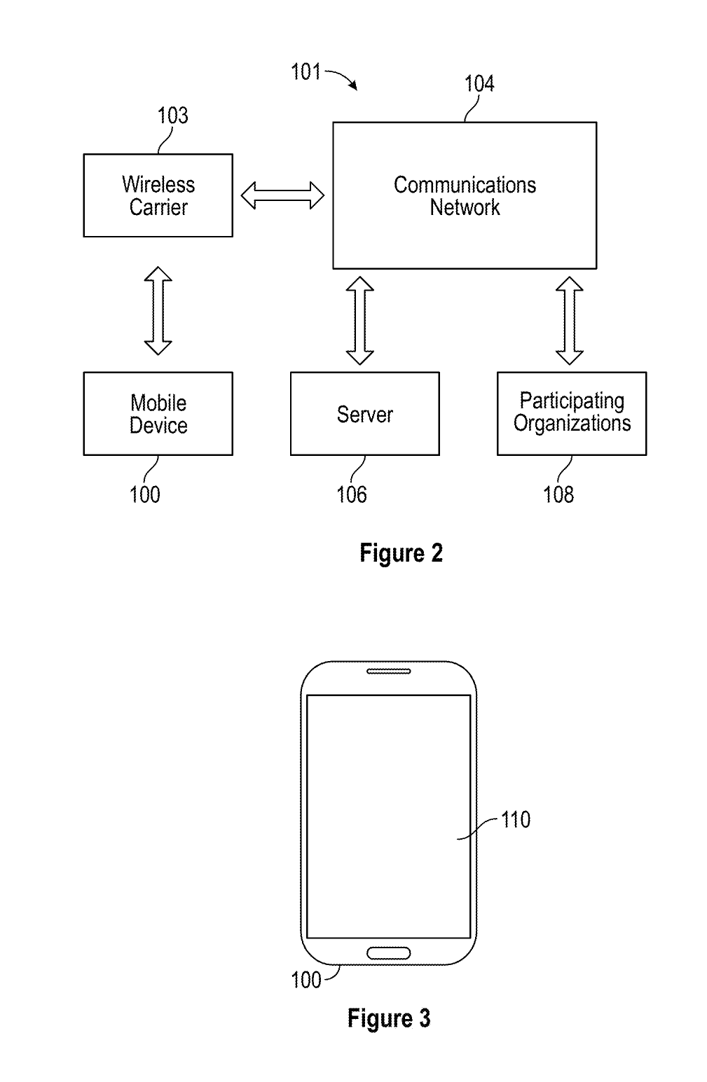

FIG. 2 is also a functional block diagram of a hybrid web/mobile application (“app”) software program based platform system 101 in which various illustrative embodiments of the invention can be implemented. System 101 includes communications network 104, which interconnects one or more participating organizations 108, one or more wireless carriers 103 (e.g., SPRINT, T-MOBILE, AT&T, etc.), one or more computer servers 106 and one or more mobile devices 100. In some embodiments, communications network 104 once again includes, but is not necessarily limited to the Internet. Like FIG. 1, FIG. 2 provides a view of the pathways wherein data is transmitted via a communications network 104 and wireless carriers 103 to run and operate the functions of the mobile application. It should be understood that the exemplary systems depicted in FIGS. 1 and 2 reflect current technology. The present invention could be adapted to operate on a different computing and communication platform as new technologies become widely used.

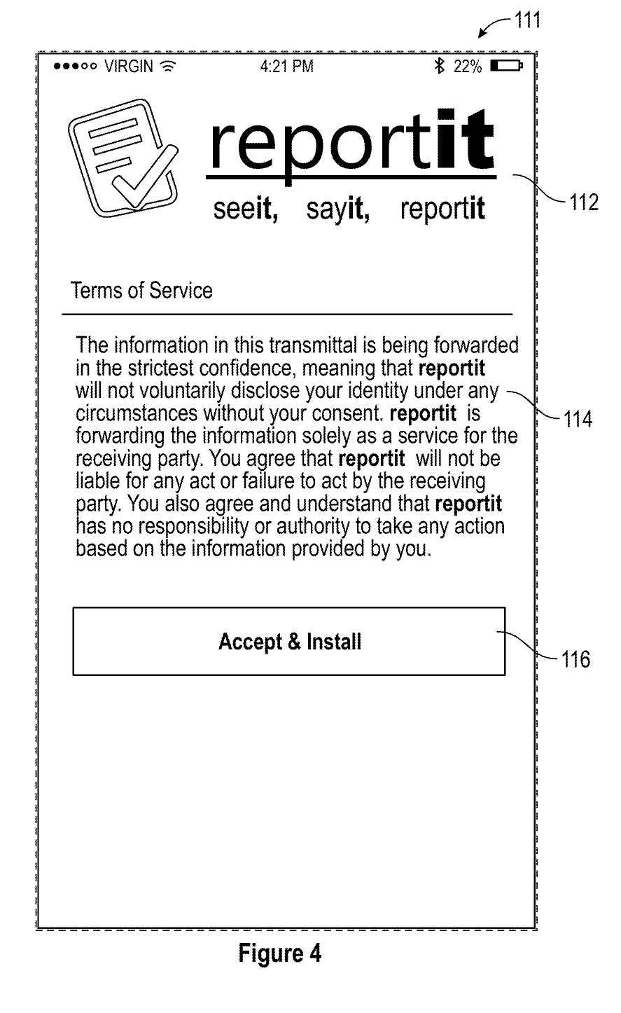

Mobile device 100, as depicted in FIG. 3 (associated with a particular user) can communicate with the various nodes of communications network 104 via wireless carrier 103 or Internet. Depending on the particular embodiment, mobile device 100 can be a cellular telephone, Personal Communication Service (PCS) phone, Personal Digital Assistant (PDA), Tablet, or other portable communication device. Additionally, the user can use mobile device 100 to download and install 116 the application software as depicted in FIG. 4 and also communicate with the server to determine if the business is a participating organization 108. FIG. 4 is also an exemplary embodiment of the initial display screen 111 for downloading the application software 116 whereby the user can be presented with information, including but not limited to the title/name of the application 112, the terms of service of the application wherein the confidentiality of the service is emphasized to the user and disclaimer information 114 can be presented, and the button to “Accept & Install” the application 116.

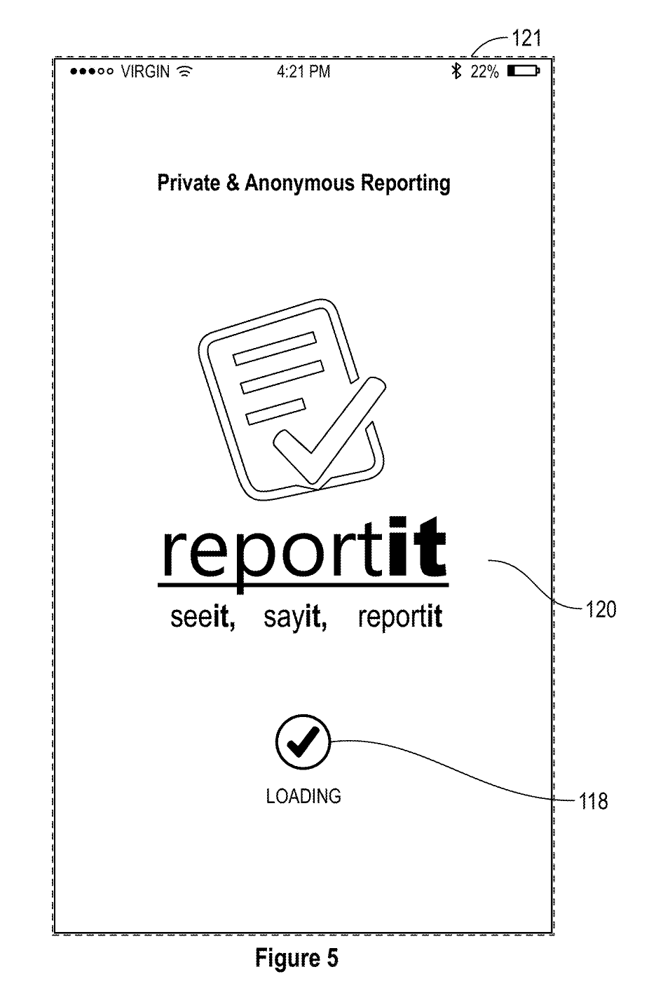

FIG. 5 is an exemplary embodiment of the invention's initial display screen 121 of the application after the application is installed and first opened by the user and can include but is not limited to items such as the name/title 120 of the application and an application operational status indictor 118. Once the user opens the application, the user can use the communications network 104 or wireless carrier 103 services to perform the location function 102 of the mobile device 100. The location function 102 of the mobile device 100, if enabled in the settings screen page 164 of the app, can be utilized to determine the location of the mobile device 100 and relay the location information to the server 106; whereby the server 106 performs a function to compare the location of the mobile device 100 with the location data of participating organizations 108. The server 106, based on its functional comparison, compiles a list 142 of participating organizations 108 based on geographical relationship to the location of the mobile device 100. The server 106 then transmits the list 142 of participating organizations 108 via the communications network 104 and/or wireless carrier 12 to the mobile device 100 running the application.

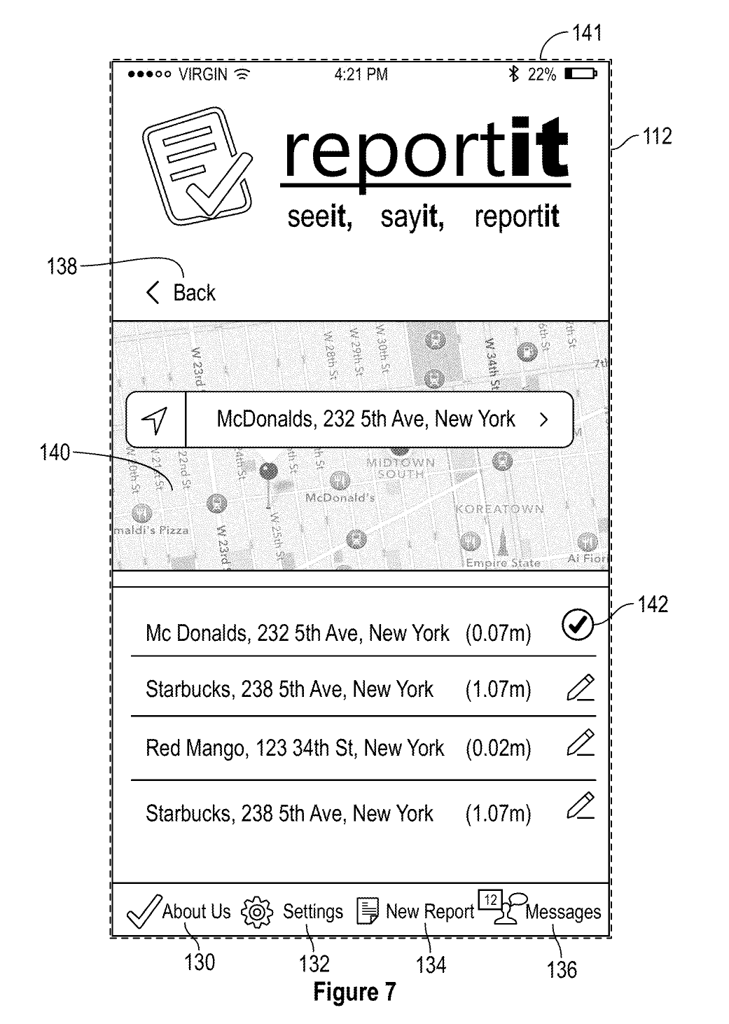

The user can view the list 142 of participating organizations 108 on the display 110 of the mobile device 100. FIG. 7 provides an example embodiment of the invention's search function response screen 141 which includes but is not limited to displaying participating organizations 108 on a map 140 utilizing a variation of symbolic markers designating the participating organizations 108 and which can also be labeled using text with the participating organizations' name. The user can “tap” on the symbol, which in turn would display further detailed information about the participating organization 108 and allow the user to verify and/or select the participating organization 108 for further use of the application. Another aspect of the example embodiment presented in FIG. 7 is the list view of the participating organizations 108 that accompanies the map 140. The information on the list of participating organizations displayed can include but is not limited to the name, address, and approximate distance of the participating organization 108 from the location of the mobile device 100 as determined by the information relayed to the server 106 by the mobile device 100.

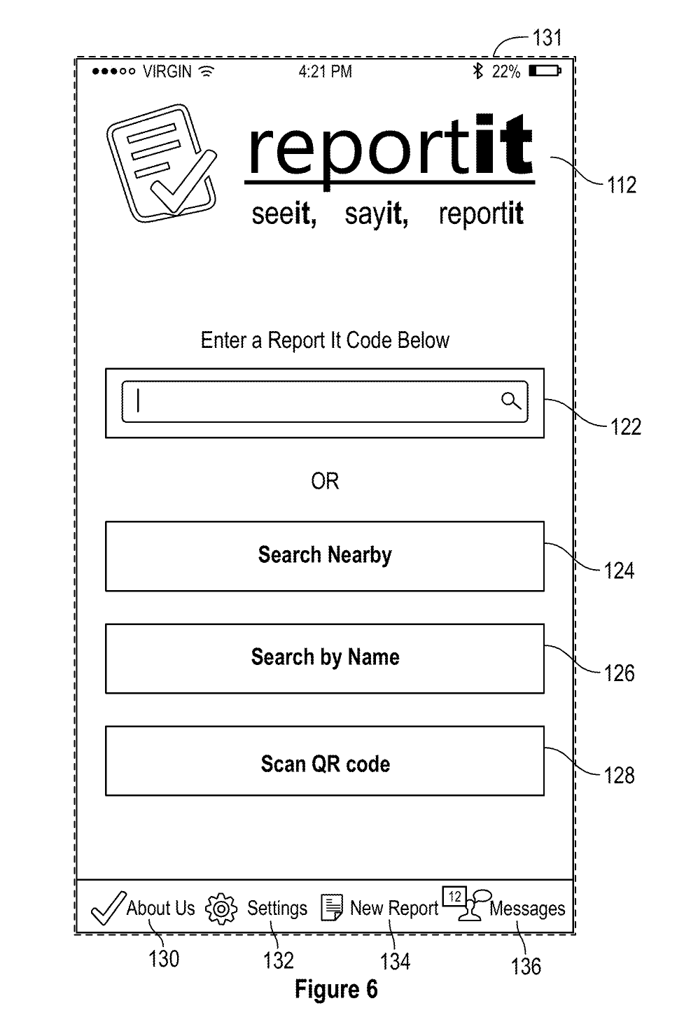

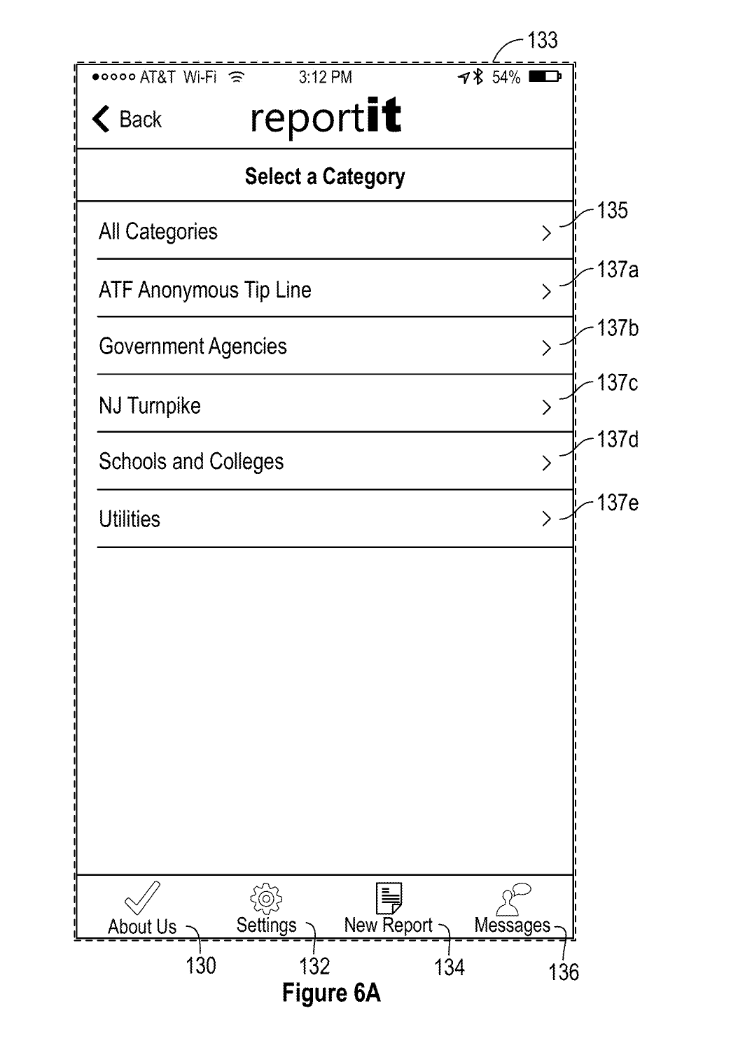

FIG. 6 presents an example embodiment of the invention's participating search function screen 131 whereby the user can select one or more alternative means of locating and selecting the participating organization 108. The options can include but are not limited to entering a participating organization 108 location specific Report It code 122 (utilizing the mobile device's 100 text keyboard) and wherein the location specific Report It code 122. can be displayed at the participating organization 108, or provided to the user by the participating organization 108, a search nearby function 124 which performs the procedure described and detailed above, a search by name 126, or scan a quick response code (“QR Code”), where in a similar manner to the location specific participating organization 108 code, can be displayed at the participating organization location and whereby the scanning function can utilize the mobile device's 100 camera functions.

FIG. 6A presents an example embodiment of the invention's participating category function screen 133 whereby the user can select the participating business or organization from either an “All Categories” option 135 or one of a number of individual business/organization categories (e.g., ATF Anonymous Tip Line 137a, Government Agencies 137b, NJ Turnpike 137c, Schools and Colleges 137d, or Utilities 137e). It should be understood that any number of additional suitable categories for businesses and organizations could be provided on the participating category function screen 133.

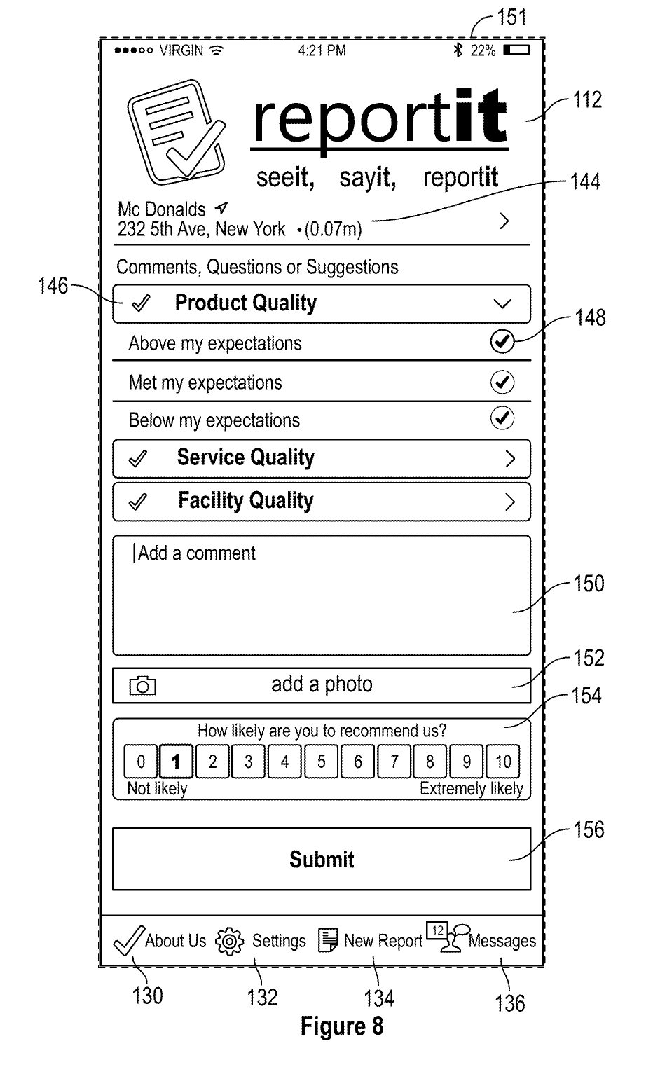

By navigating either search function screen 131, 133, the user finds the participating organization they want to select, confirms from the information displayed that the participating organization 108 is the correct one, and makes the selection. Once the user makes the participating organization 108 selection, the information for the selected participating organization 108 is relayed to the server 106 over a communications network 104. The server uses the selection information to retrieve the location specific questionnaire report template for the selected participating organization location 108. An example screen display for a location specific questionnaire report is provided in FIG. 8 as indicted by item 151. The report questionnaire is then completed by the user to include but is not limited to answering or bypassing the previously populated form questions 148 under the previously determined categories 146, typing text into the box 150 whereby the user can provide descriptive comments or concerns not otherwise covered by the predetermined categories. The user also will have the capability to take and or attach a photo or video including location data to the questionnaire report using the function button for adding a photo 152. Further, an additional type of feedback the user can provide is to complete the “Net Promoter Score System” (NPS) rating scale if it is included in the report questionnaire 154.

The user then submits the completed report questionnaire by utilizing the submit button on the report 156. Once the report questionnaire is submitted via the application the information is sent to the server 106 utilizing a wireless carrier 103 and/or communications network 104. Based upon information provided by the participating organization 108 a notification that a new report has been received is relayed immediately to designated recipients within the participating organizations 108 via e-mail and/or text message utilizing the communications network 104. If using the mobile device application the user will be informed that they will receive a response (if any) from the business via push notification. Another variant of an embodiment of the invention includes where the user can be provided the option to use a Facebook™, LinkedIn™ or Google+™ account linked to the application to receive a response or remain anonymous.

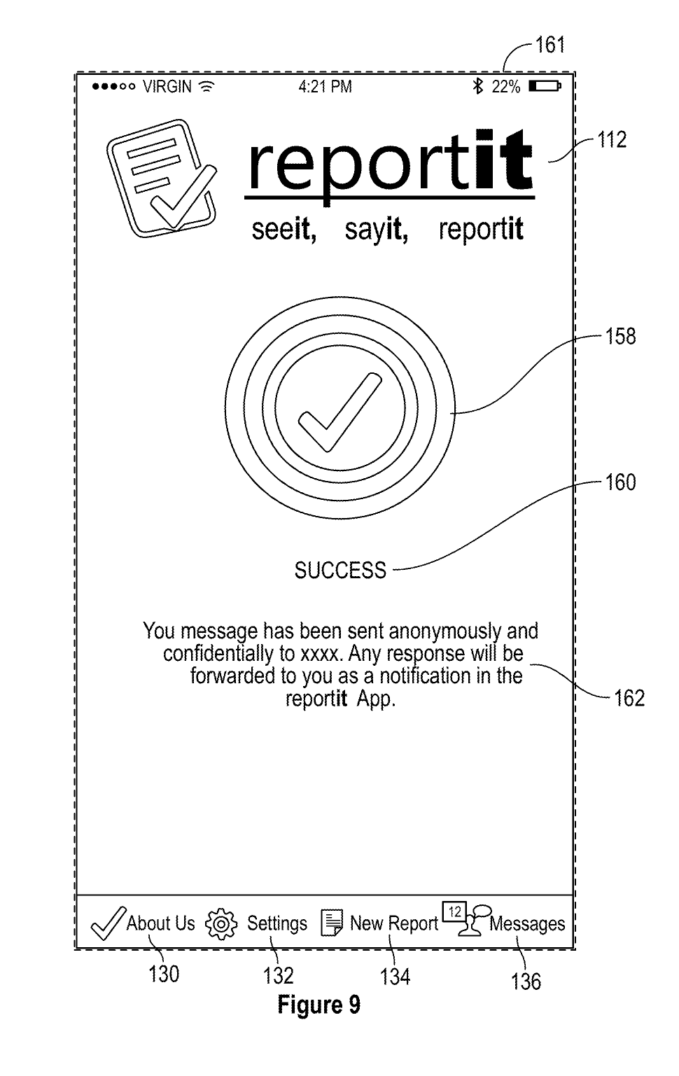

FIG. 9 is an example of the questionnaire report transmission screen 161. The questionnaire report transmission screen can include but is not limited to a report status indicator symbol 158, report status indicator text 160, and text information 162 reemphasizing the questionnaire report was sent anonymously and confidentially in addition to indicating to which participating organization 108 the report questionnaire was sent. Report status information can include but is not limited to indicators such as: “Success”, “Loading”, and “Failed.” If a report failed to submit, the application may include the option and specific user interface button to resubmit the report. The user interface button to reattempt the submission of a report in the application may be but is not limited to “Try Again.”

In an exemplary embodiment of the invention the application displays a tool bar at the lower portion of the application's display screens 131, 141, 151, 161, 171. This tool bar provides buttons for options that can include but are not limited to “About Us” 130 wherein the user can obtain information such as the application's developers and its purpose, “Settings” 132 wherein the user can adjust the settings of the application to his or her preferences, “New Report” 134 wherein the user can select the option to create a new report, and “Messages” 136 wherein the user can view the submitted report information, delete reports from the mobile device 100, and/or retrieve responses from participating organizations 108.

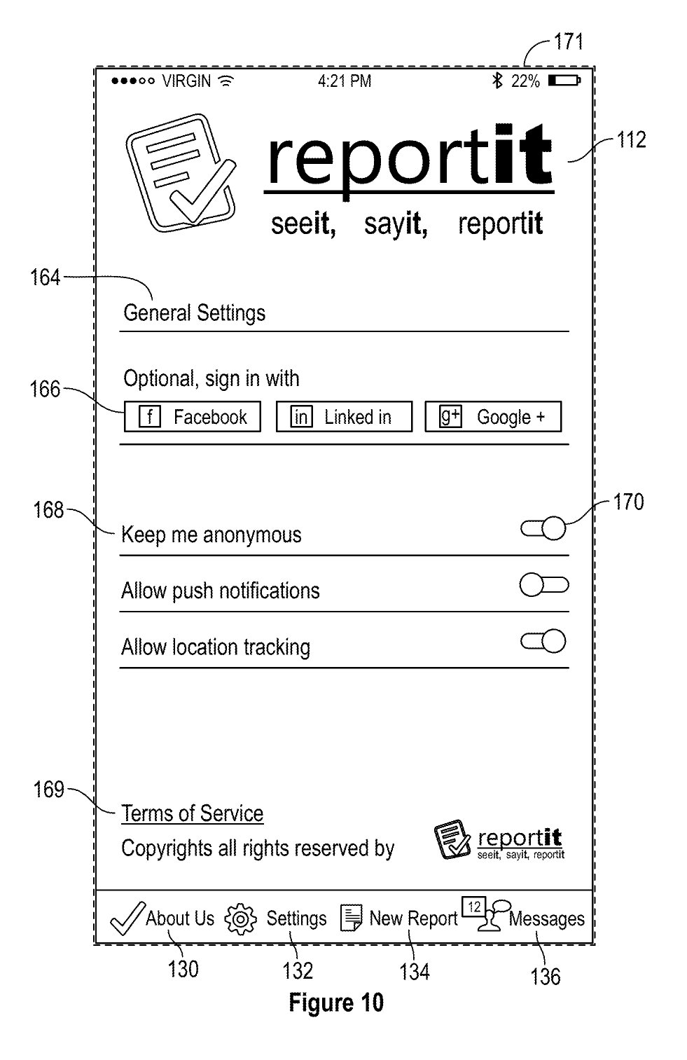

FIG. 10 is an example of the application's settings screen 171. The settings screen is generally accessible from almost every other screen of the application via the tool bar at the lower portion of the application's display screens 131, 141, 151, 161, 171. Exemplary information generally found in the settings of the application can include, but is not limited to, the title of the settings screen page 164, user interface buttons to select and login into the application using the login information of another social media account such as Facebook™, LinkedIn™ or Google+™ 166, privacy option selections 168, and a button to access the full text of the “Terms of Service” 169 for the application.

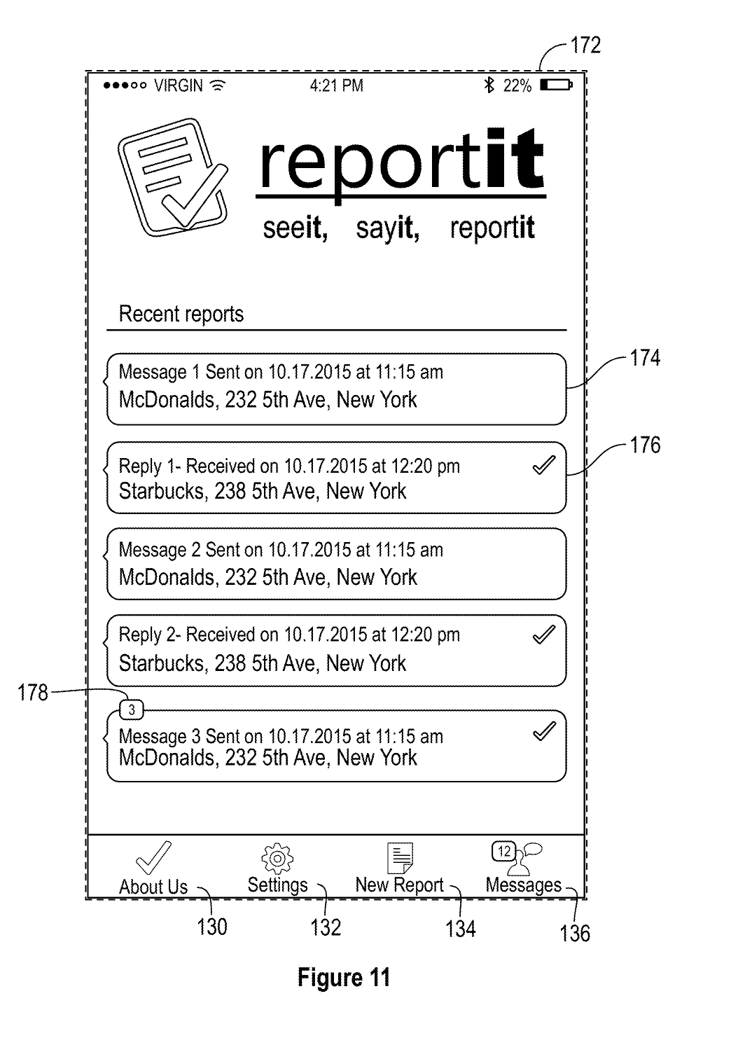

FIG. 11 is an example of the questionnaire sent report message screen 172. The questionnaire sent report message screen 172 can include but is not limited to text information of message indicators of sent reports 174 and message indicators of replies 176 to the submitted reports. In addition to the message indicator of sent report 174 the embodiment of the invention can include a number indicator 178 associated with the message chain of a submitted report to indicate the number of messages and responses within the message chain.

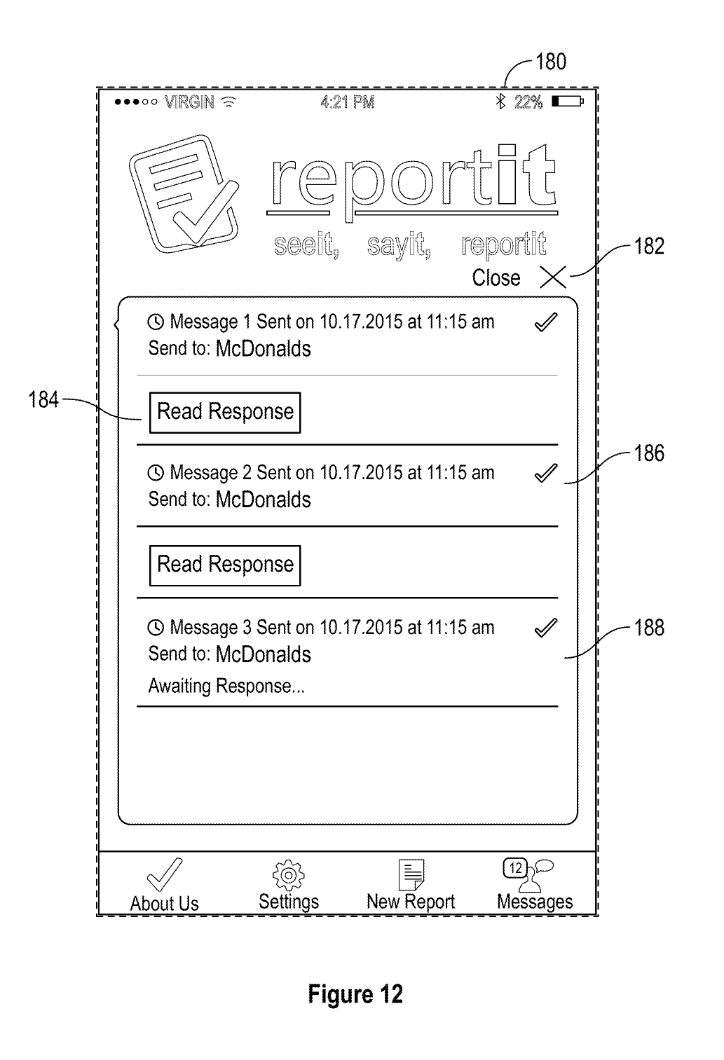

An example of the display screen of the report message chain is presented in FIG. 12. In alternate embodiments of the invention, this report message chain screen may be omitted from the invention. Once the report message chain screen is open, it includes, but is not limited to, the listing of information on the report that was submitted 180, including the date and time the report was submitted, the recipient participating organization of the report, a button to open a screen for the responses sent by the recipient of the report 184, and message status indicators 188. The example embodiment of the message chain screen also includes a button to close the screen 182 whereby the user can return to the previous screen.

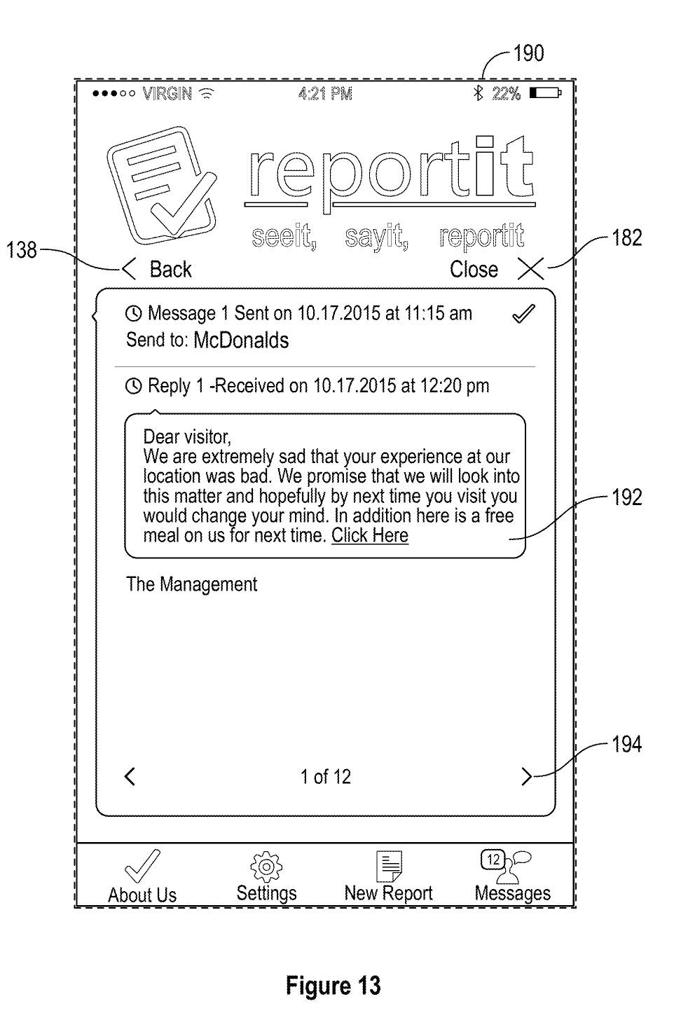

An example of the display screen of the message detail 190 is presented in FIG. 13. Once the message detail screen is open, it includes, but is not limited to, the date and time the report was submitted and the recipient participating organization of the report. In addition to the previously stated features, the message detail screen can also include the text display of the response from the participating organization 192 and arrow buttons 194 to allow the user to scroll from one message to another within the chain or to all messages within the message box of the user.

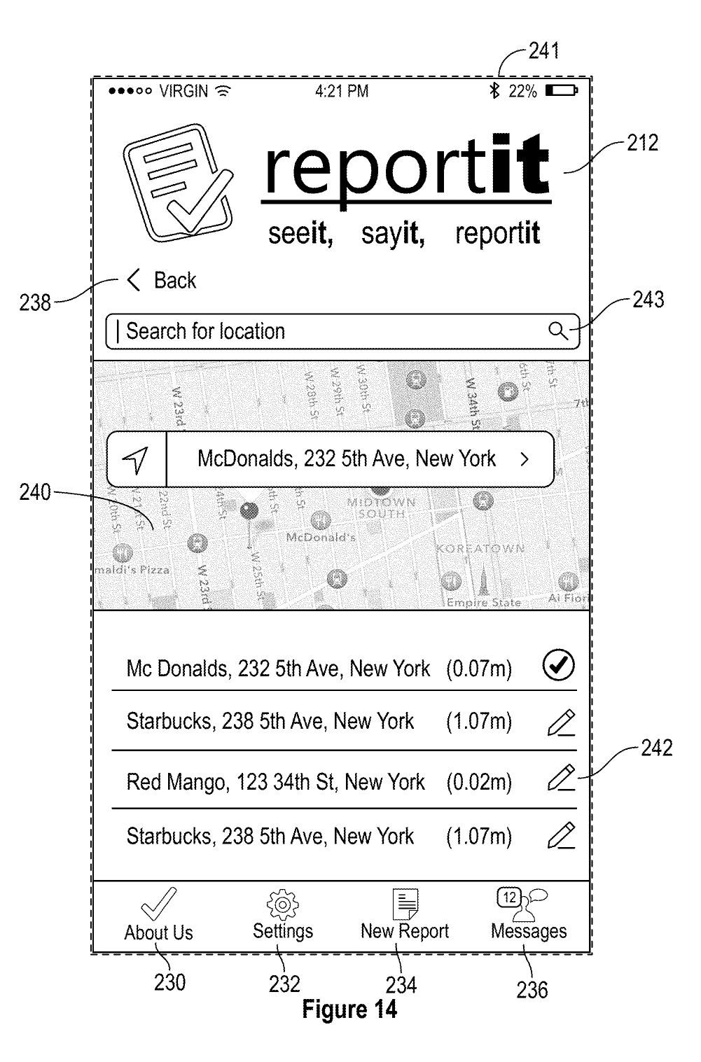

In the figures, elements that are similar to those of other embodiments of the present invention are represented by reference numerals increased by a value of 100. Such elements should be regarded as having the same function and features unless otherwise stated and/or depicted herein, and the discussion of such elements may therefore not be repeated for multiple embodiments. For example, the map view 140 in FIG. 7 corresponds to the map 240 in FIG. 14. However, the example embodiment in FIG. 14 also includes a text entry box for a search feature 243.

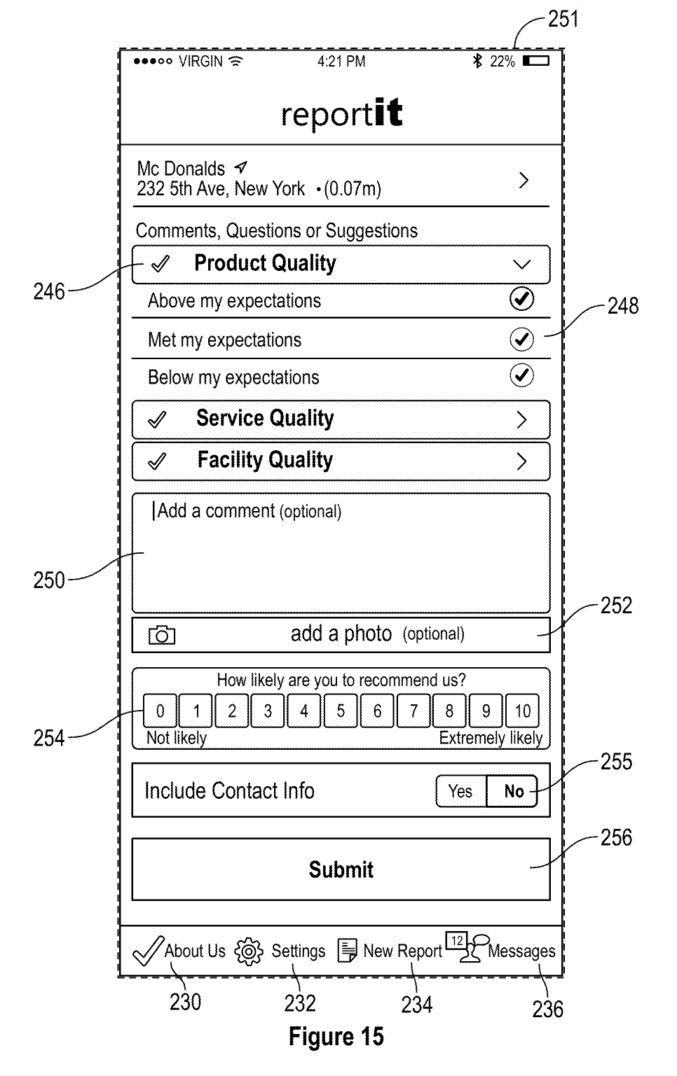

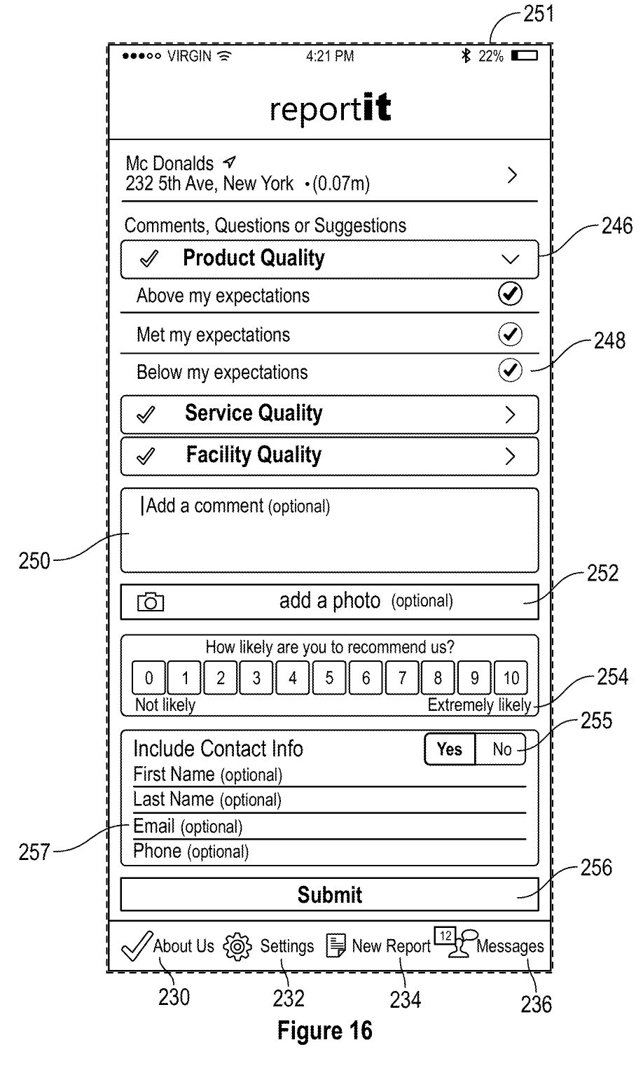

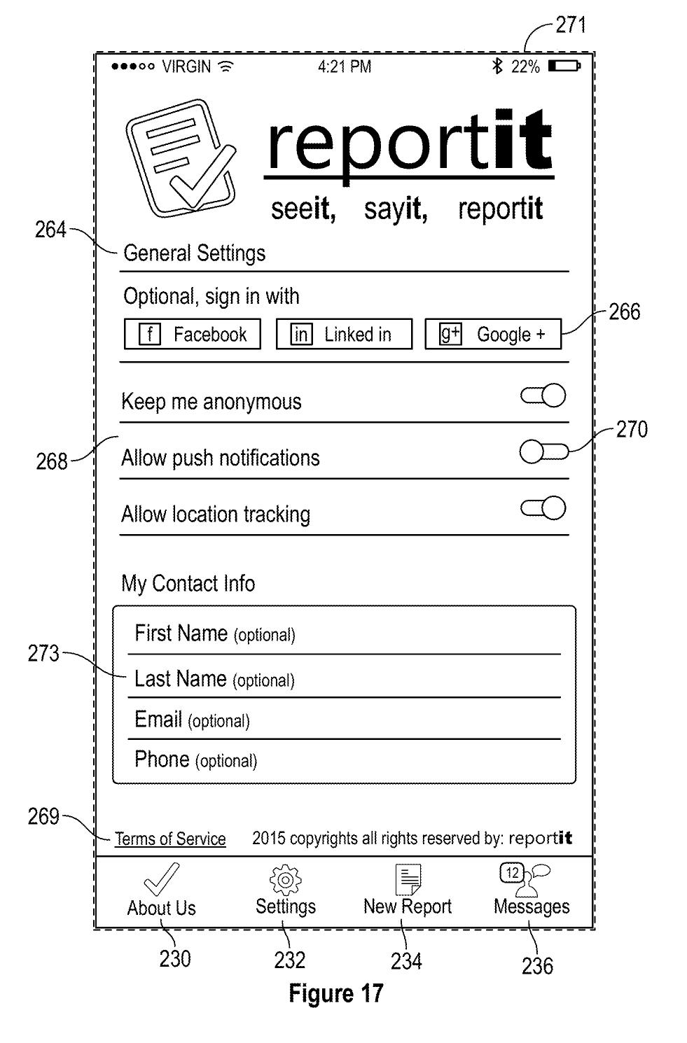

Other figures presented are also alternate embodiments of the invention. FIG. 15 and FIG. 16 present alternate embodiments of screen displays of FIG. 8 whereby FIG. 15 and FIG. 16 include all the previously detailed features of FIG. 8 but also include but are not limited to a button to include user contact information 255 and a user contact information text entry form 257. Likewise, FIG. 17 is an alternate embodiment of FIG. 10, whereby it incorporates all the previously presented features of FIG. 10 but also includes but is not limited to the addition of a user contact text entry form 273 wherein the information is saved within the program for later use and saves time for the user so they don't have to retype the information into multiple reports.

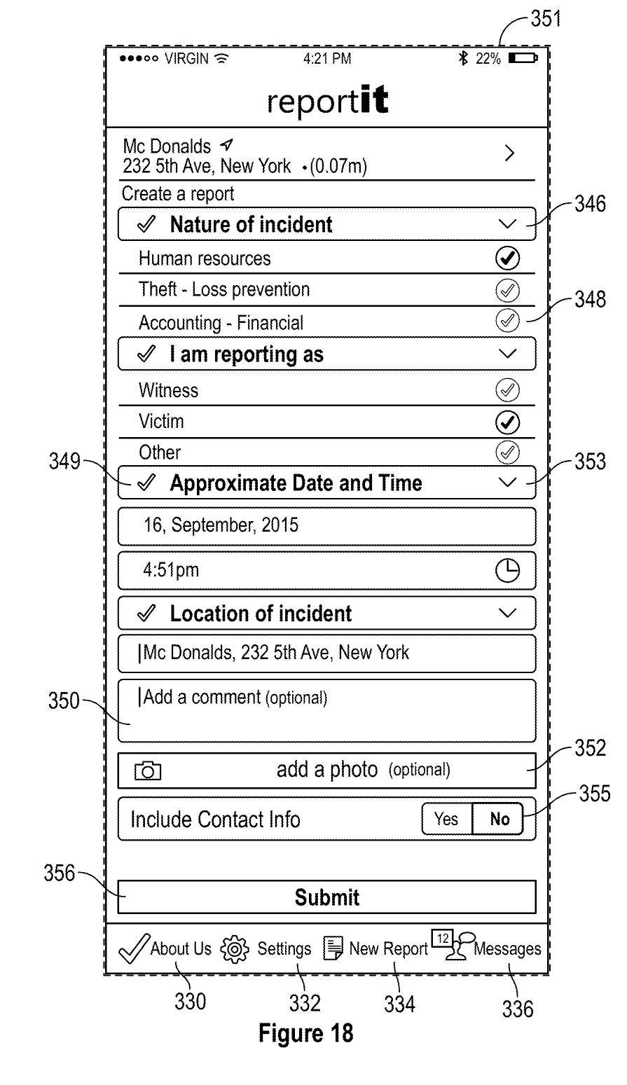

Similarly, FIG. 18 is an example of an alternate embodiment of FIG. 8 whereby the report questionnaire 351 in FIG. 18 includes but is not limited to questions and the input of information in regards to a specific incident. The report questionnaire 351 may be used to report human resource or law enforcement information. The report questionnaire 351 in FIG. 18 incorporates all the previously presented features of FIG. 8 but also includes but is not limited to the addition of features requesting date and time information 349, requesting location information 353, and the option to include user contact information 355.

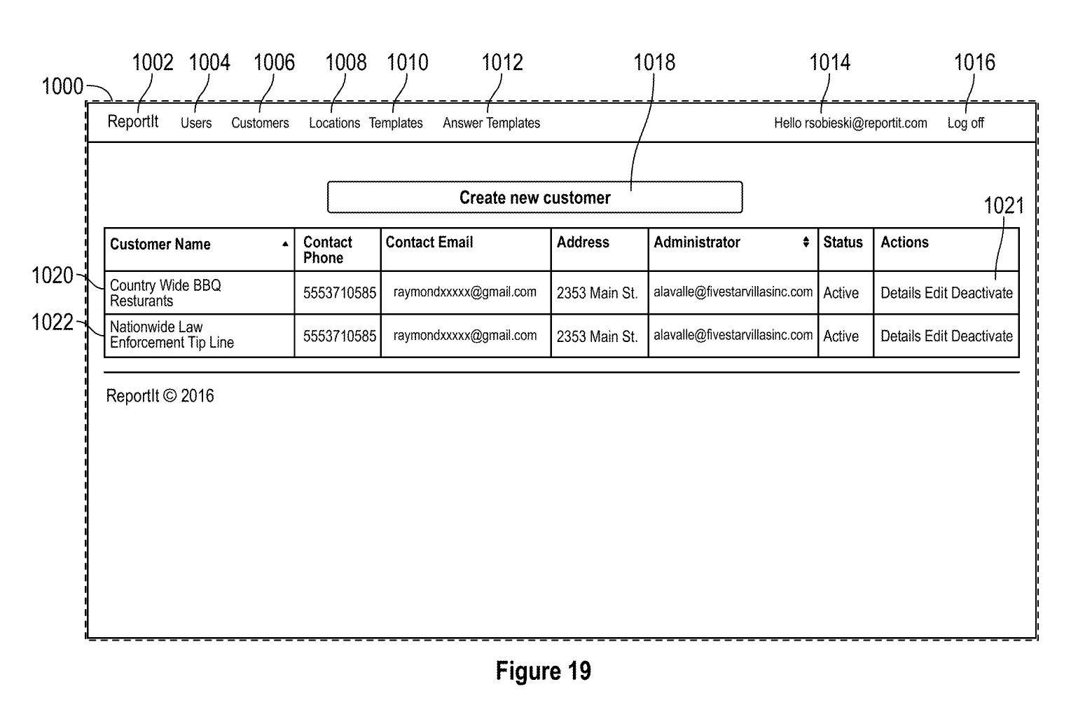

Once a report is submitted the report is sent via a communications network 104 to the server 106 and it will be added to the server database. The server 106 is the functional element of the invention providing the means to process the incoming report notification to the appropriate recipient based upon the report routing protocol. The server 106 additionally performs but is not limited to providing a means for the client participating organizations 108 to control his or her account features. The customer backend, one of the invention's programs at the server 106, is the tool that participating organizations 108 will use for file creation, account maintenance, as well as accessing the reporting dashboard (shown in FIGS. 19 to 28).

The backend can be accessible via the reporting service's webpage whereby the customer participating organizations 108 can gain access to the backend by utilizing a username and password 1014. Typically, the management of the reporting service will initially set up the features of the backend participating organization master file and participating organization system administrator. Further, the backend tool can provide but is not limited to the additional functions of adding/modifying/deleting users, adding/modifying/deleting reporting locations within an organization, creating appropriate signage or QR codes, providing access to the reporting tools and dashboard, replying to a report, and changing the status of a report (i.e. new, viewed, active, archived, etc.).

The backend initial access screen can include but is not limited to displaying buttons for links to specific customer participating organization account information. Examples of the types of information are contact information (i.e. name of organization, phone number, address, e-mail, etc) 1006, location information 1008 of branches or franchises of the participating organization if applicable, templates of reporting questionnaires 1010, and answer templates 1012 for responses by participating organizations to submitted reports.

An example embodiment of the reporting service customer participating organization backend tool customer listing/create new customer entry screen 1000 is presented in FIG. 19. The embodiment includes but is not limited to buttons to move to the entry/edit customer information page 1018, the display of categorical listing 1020 of customer information 1022, and hyperlink buttons for links to details, editing, and deactivating the customer access or information 1021.

Other features included on this screen of the backend embodiment are presented in a tool bar feature at the top of the screen whereby each screen contains user interface buttons to move to other screens with specific information. The example user interface button standard features in the tool bar section 1002 of the backend screens include buttons to get to user information 1004, customer information 1006, location information 1008, template information 1010, answer template information 1012, the login information indicator 1014, and the log off button 1016.

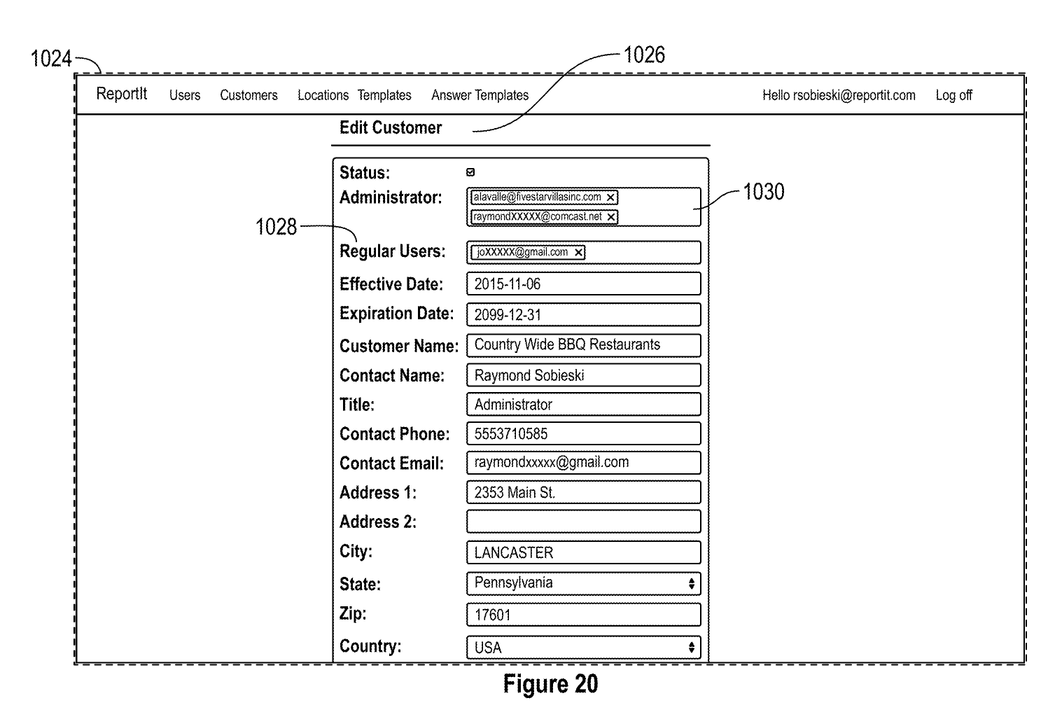

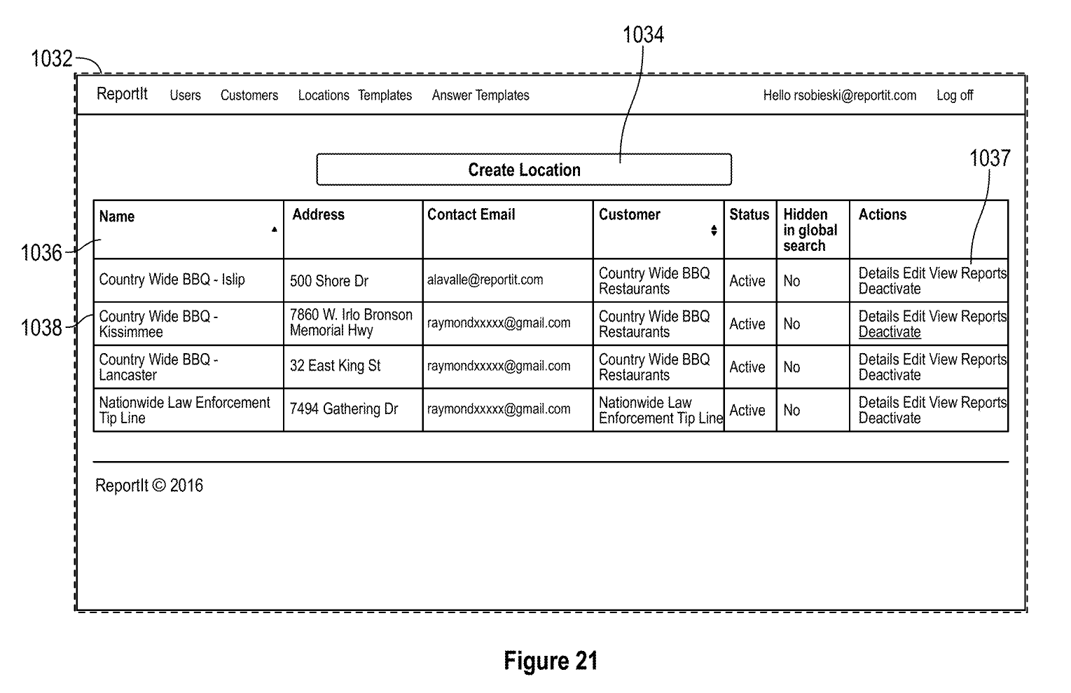

An example embodiment of the reporting service customer participating organization backend tool enter/edit customer information screen 1024 is presented in FIG. 20. The enter/edit customer information screen 1024 includes but is not limited to the toolbar feature 1002 in addition to a listing of categories for customer information 1028 and text entry boxes 1030 for the reporting service management or participating organization to enter the information corresponding to the categories.

An example of the reporting service customer participating organization backend tool customer listing/create new customer location entry screen 1032 is presented in FIG. 21. The listing/create new customer location entry screen 1032 includes but is not limited to buttons to move to the entry/edit customer location information page 1034, the display of categorical listing 1036 of customer location information 1038, and hyperlink buttons for links to details, editing, viewing reports, and deactivating the customer location access or information 1037.

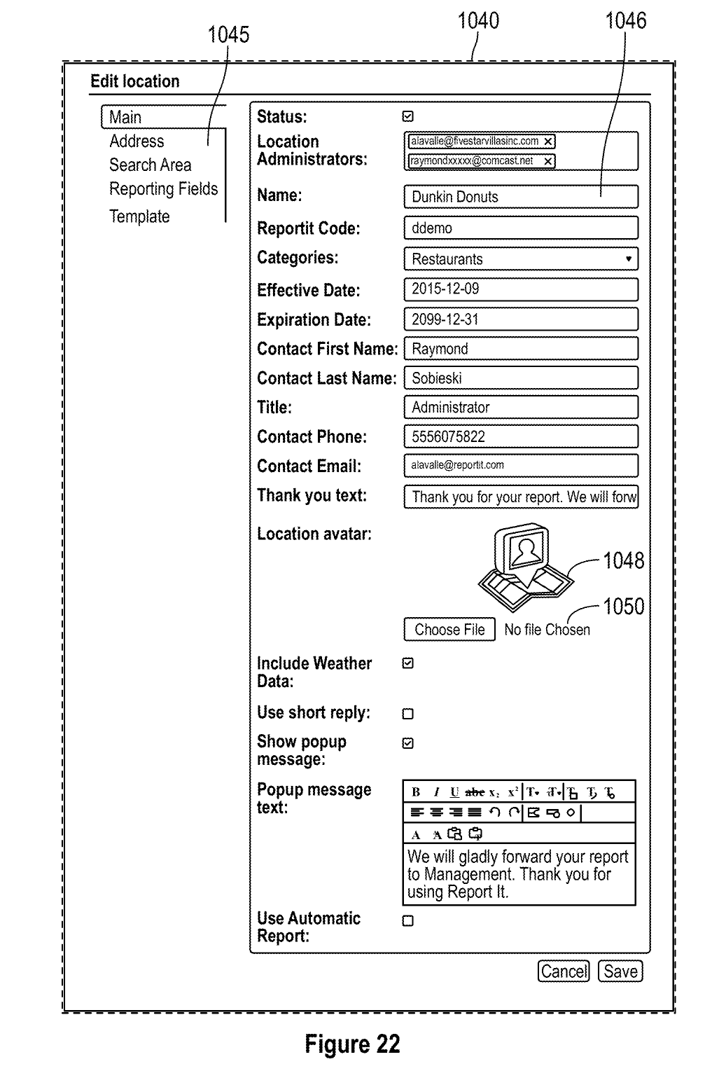

The example embodiment of the edit location feature of the backend tool is presented as containing five specific tabs for the input and inclusion of participating organization customer information and the other developmental use of the reporting service. FIG. 22 presents an example embodiment of the reporting service customer participating organization backend tool enter/edit customer location main information tab screen 1040. The reporting service customer backend tool enter/edit customer location main information tab screen 1040 includes but is not limited to a listing of categories 1045 for customer information, text entry boxes 1046, and the ability to attach a photo or picture of the customer's logo or location avatar 1048 or other identifier by utilizing the “choose file” user interface button 1050. When a location is selected by the user in the edit location feature screen of FIG. 22, a pop-up warning screen appears which includes hyperlink capabilities including at least one phone number, website link, and contact e-mail address. This mode of the invention permits weather data to be included in the report details. It also provides the ability to automatically reply to the user when a report is submitted, or to view a short version of the report. It should be understood that any mode or embodiment of the present invention could include collecting publicly-available weather data for the user's location and/or participating organization's location and including that weather data in the report details.

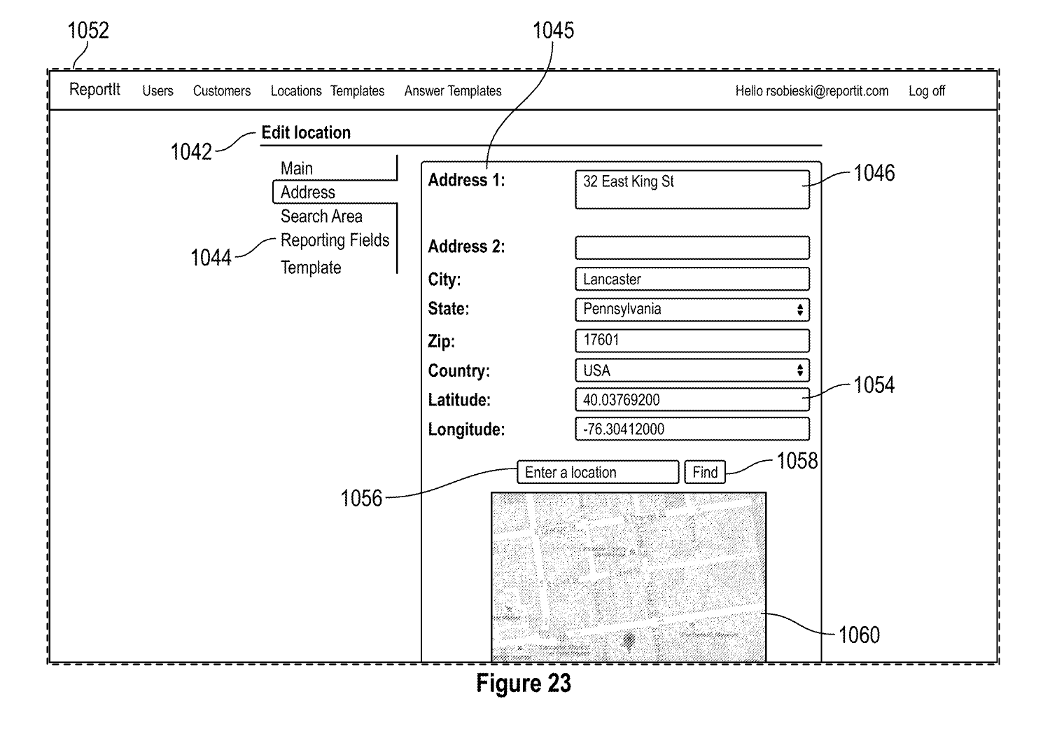

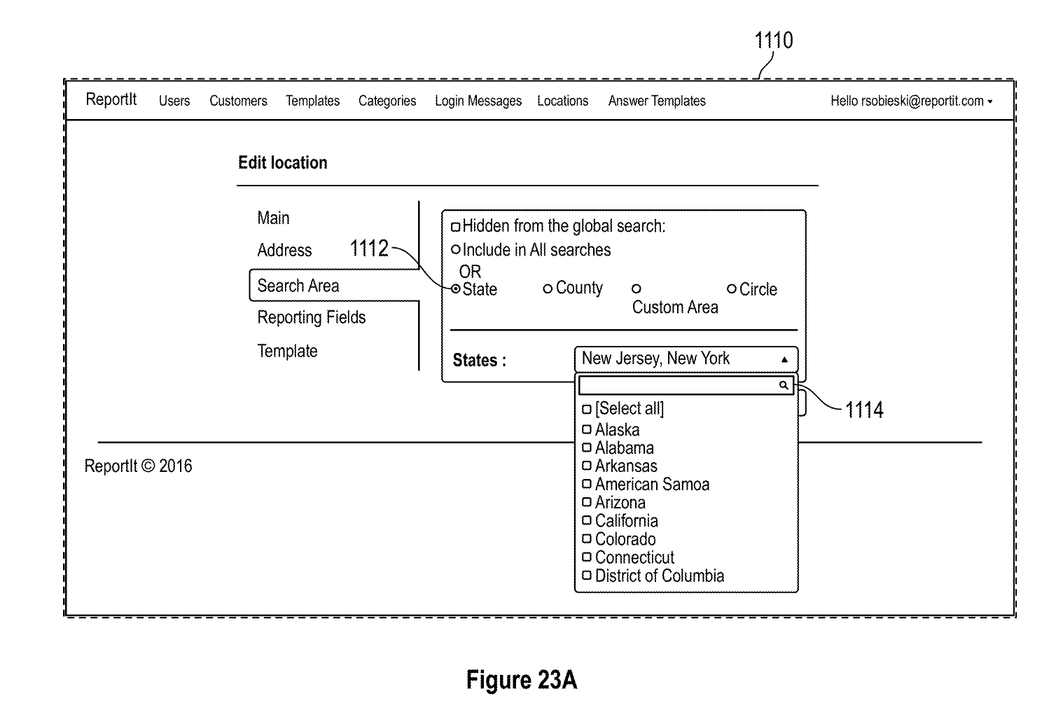

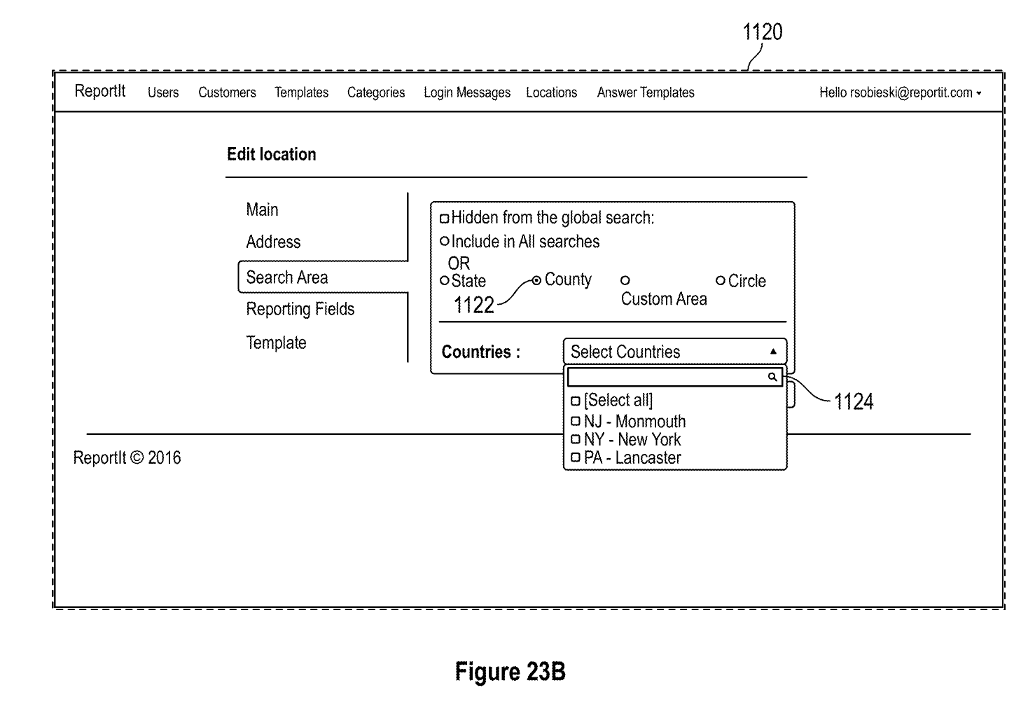

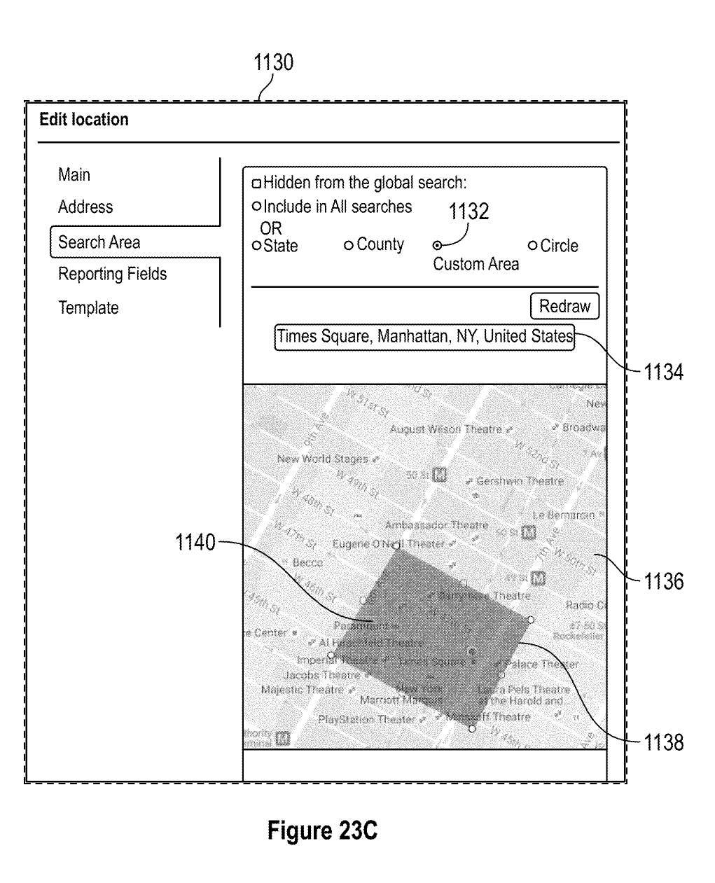

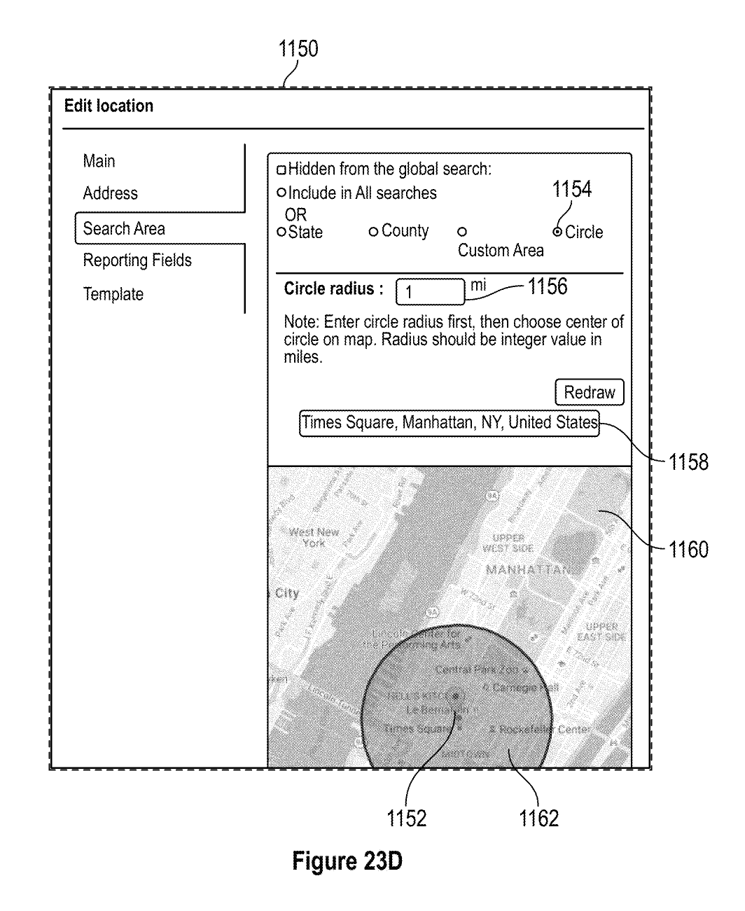

FIG. 23 presents an example embodiment of the reporting service customer participating organization backend tool enter/edit customer location address information tab screen 1052. The reporting service application customer backend tool enter/edit customer location address information tab screen 1052 includes but is not limited to a listing of categories 1045 for customer address information, text entry boxes 1046, a search function to locate an address 1056 with “find” function user interface button 1058, and a map function with a map display 1060.

FIGS. 23A-23D present example embodiments of the reporting service customer participating organization backend enter/edit location search tool for searching the relevant location based on a variety of geographic search methods, in particular by using various geofencing/geolocation tools or political units (e.g., city, county/parish, state/province, country), as described below in detail. For all of the various embodiments shown below, a new location will always be shown the user based on the default location.

FIG. 23A shows an example of a search tool screen 1110 for searching the relevant location based on state. When the system administrator selects the “State” radial button 1112 on the screen 1110, the system administrator may select one or more states (e.g., New Jersey, New York) from the search window 1114 using an autocomplete function. In this embodiment, locations designated by one or more states use the information provided by Google U.S. State KML Fusion tables to establish the Geo-Fence. A new location will be shown to a user only if it is within the bounds of one or more selected states.

FIG. 23B shows an example of a search tool screen 1120 for searching the relevant location based on county. When the system administrator selects the “County” radial button 1122 on the screen 1120, the system administrator may select one or more counties (e.g., N.J.-Monmouth, N.Y.-New York) from the search window 1124 using an autocomplete function. In this embodiment, locations designated by one or more counties use the information provided by Google U.S. County KML Fusion tables to establish the Geo-Fence. A new customer location will be shown to a user only if it is within the bounds of the one or more selected counties.

FIG. 23C shows an example of a search tool screen 1130 for searching the relevant location based on a custom polygon tool that enables the system administrator to manually select the bounds of the geographic area in which they would like for search results to be returned. When the “Custom Area” radial button 1132 is selected on the screen 1130, a search field 1134 appears wherein the system administrator can insert an address or portion thereof in order to pull up a map view of the inserted address/area within a map view window 1136. The system administrator then selects the bounds (e.g., corners) of a custom polygon 1138 within the map view window 1136 and adjusts the bounds of the custom polygon search area indicator 1140 accordingly to establish the Geo-Fence. The custom polygon tool may be useful in the case of defining neighborhoods, unofficial geographic boundaries (e.g., “Lehigh Valley” or “New Jersey Shore”), or other non-specific areas (e.g., an airport complex). A new customer location will be shown to a user only if it is within the boundaries of the custom polygon search area indicator 1140, which is shown here as a shaded area within the edges of the custom polygon 1138. In some embodiments, user locations outside of the custom polygon search area indicator 1140 would be included on the location search result list, but would not appear in the map view window 1136.

FIG. 23D shows an example of a search tool screen 1150 for searching the relevant location based on a search radius tool that enables the system administrator to manually select the bounds of the geographic area by defining a centerpoint 1152 and radius value (measured from the defined centerpoint 1152) in which they would like for search results to be returned. When the “Circle” radial button 1154 is selected on the screen 1150, a Circle Radius field 1156 appears in which the system administrator may input the search circle radius up to some predetermined maximum value (e.g., 50 miles). Once the system administrator enters a numerical value into the Circle Radius field 1156, a search field 1158 appears wherein the system administrator can insert an address or portion thereof in order to pull up a map view of the inserted address/area within the map view window 1160. The map view window 1160 will then generate the circular search area indicator 1162 having the selected centerpoint 1152 and radius to establish the Geo-Fence. A new customer location will be shown to a user only if it is within the boundaries of the circular search area indicator 1162. In some embodiments, user locations outside of the circular search area indicator 1162 would be included on the location search result list, but would not appear in the map view window 1160.

Another method for a system administrator to define the geographic boundaries of a search area involves using one or more U.S. Congressional districts as the defining geographic unit. By interfacing with published congressional district data (e.g., Fusion Table data published by Google), a Geo-Fence search area encompassing one or more U.S. Congressional districts could be established that functions in the same manner as the Geo-Fenced areas discussed above in detail.

For any of the various geo-fencing/geolocation methods taught above, once a user selects “Search Nearby” or “Search by Name” in the software application 116, the database would look at the GPS coordinates provided by the user's mobile device 100 and create a subset of locations that are displayed to the user if they are within the bounds of the defined locations. Business or organization categories function in the same way as described above.

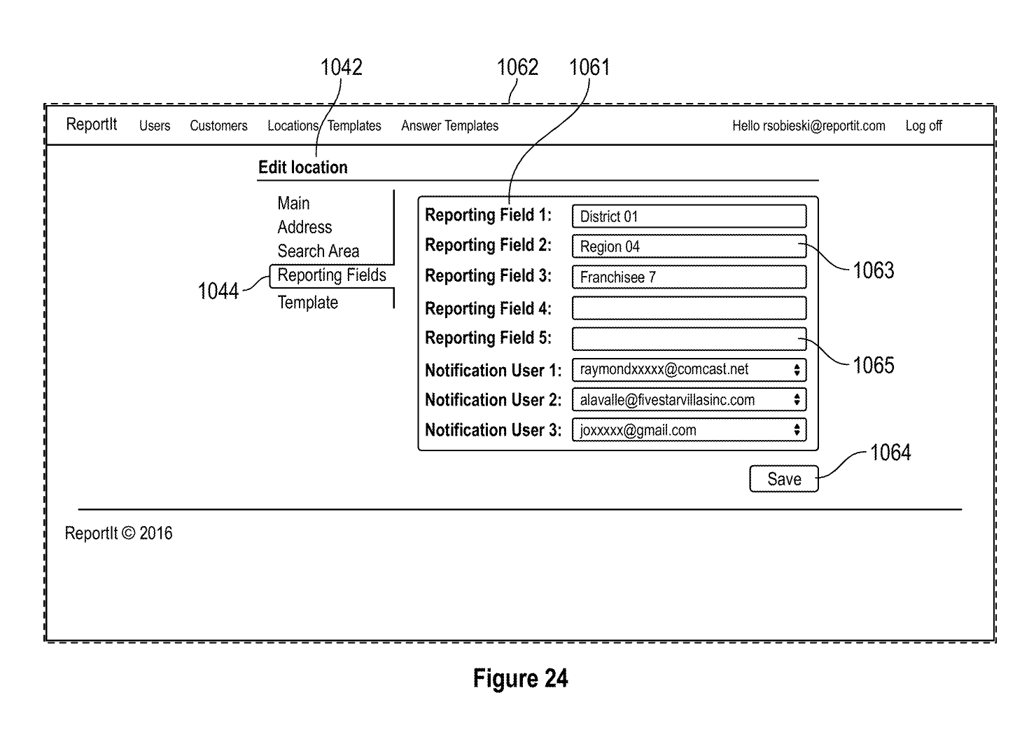

FIG. 24 presents an example embodiment of the reporting service customer participating organization backend tool enter/edit customer location reporting fields information tab screen 1062. The enter/edit customer location reporting fields information tab screen 1062 includes but is not limited to a listing of categories for customer information for reporting location designations 1061, report notification information designations 1065, text entry boxes 1063, and a save function button 1064.

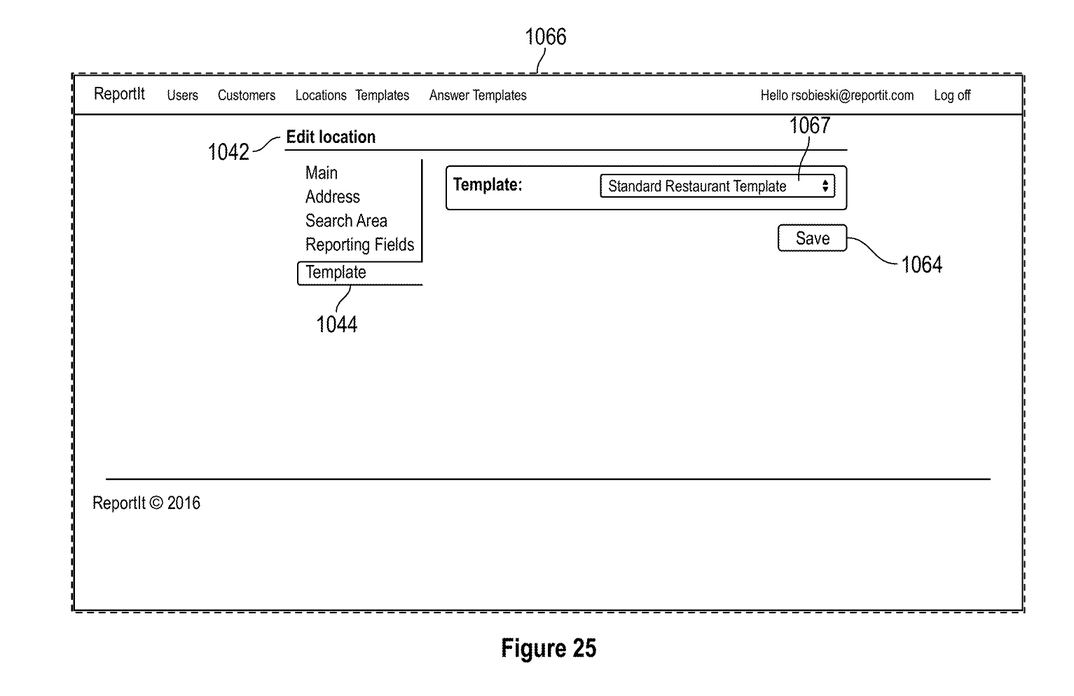

FIG. 25 presents an example embodiment of the reporting service customer participating organization backend tool enter/edit customer location template information tab screen 1066. The enter/edit customer location template information tab screen 1066 includes but is not limited to a listing of template tab designation 1044, template category/selection box 1067, and save function button 1064.

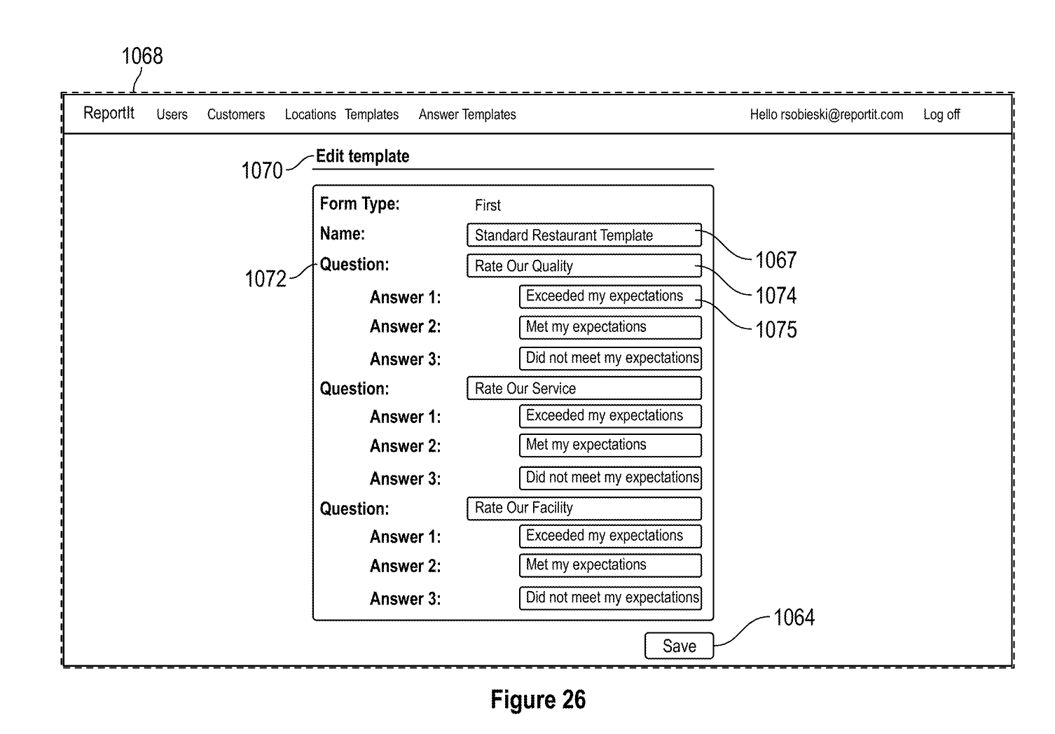

From the selection of the template from the enter/edit customer location template information tab screen 1066 or by selecting the button in the tool bar for the template, the next screen displayed is the reporting service application customer backend tool edit template screen 1068 as presented in the example embodiment of FIG. 26. The edit template screen includes but is not limited to a listing of categories of template information 1072, the type of report questionnaire 1067, report questionnaire questions 1074, answer information 1075, or pre-populated boxes with question and answer information for selection by the customer and a save function button 1064.

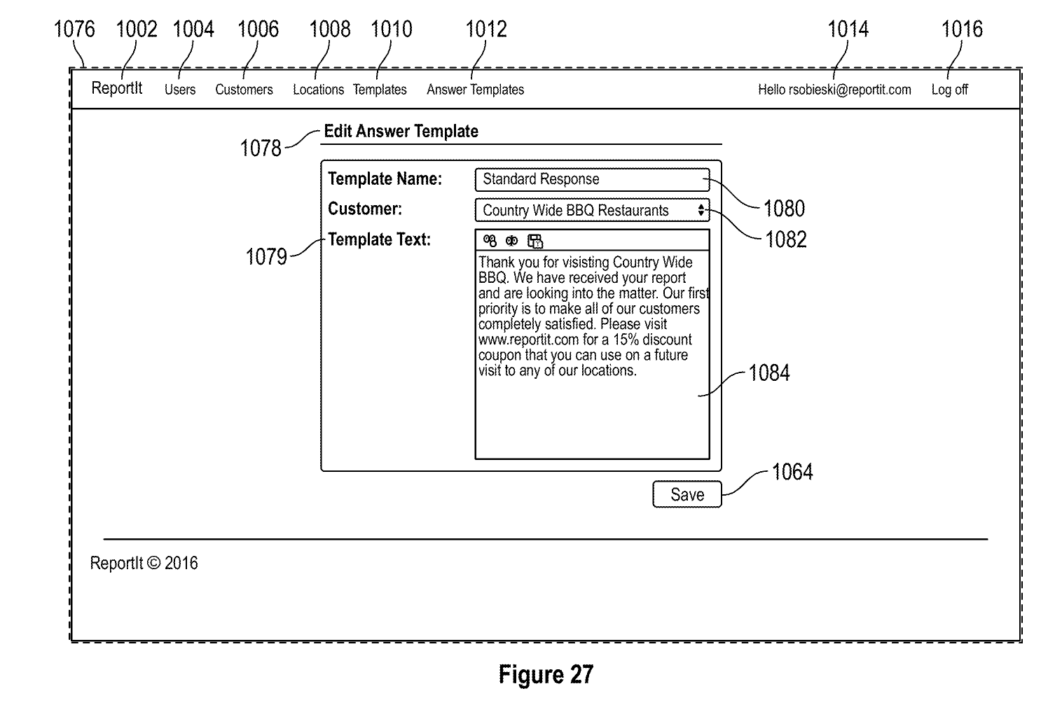

The backend tool is also used to access the edit answer template screen 1076 as presented in the example embodiment of FIG. 27. The edit answer template screen 1076 includes but is not limited to a listing of categories of response answer template information 1079, customer information 1082, answer information 1080, and text boxes to input the customer participating organization's response 1084 to report submissions or pre-populated boxes with response answer information for selection by the customer and a save function button 1064.

Once the participating organization 108 completes the template configuration and the reporting service is activated the participating organization 108 will begin receiving new report notifications when submitted by users. Depending upon the report routing protocol selected by the system administrator or designated official of the participating organization 108, the participating organization recipients may receive report notifications in real time, a daily batch of reports, or as a periodic summary of key information. The reporting protocol structure will be comprehensive and provide functionality to ensure only authorized recipients have access to any potentially sensitive information. New report notifications can be sent to recipients via e-mail, text message or both.

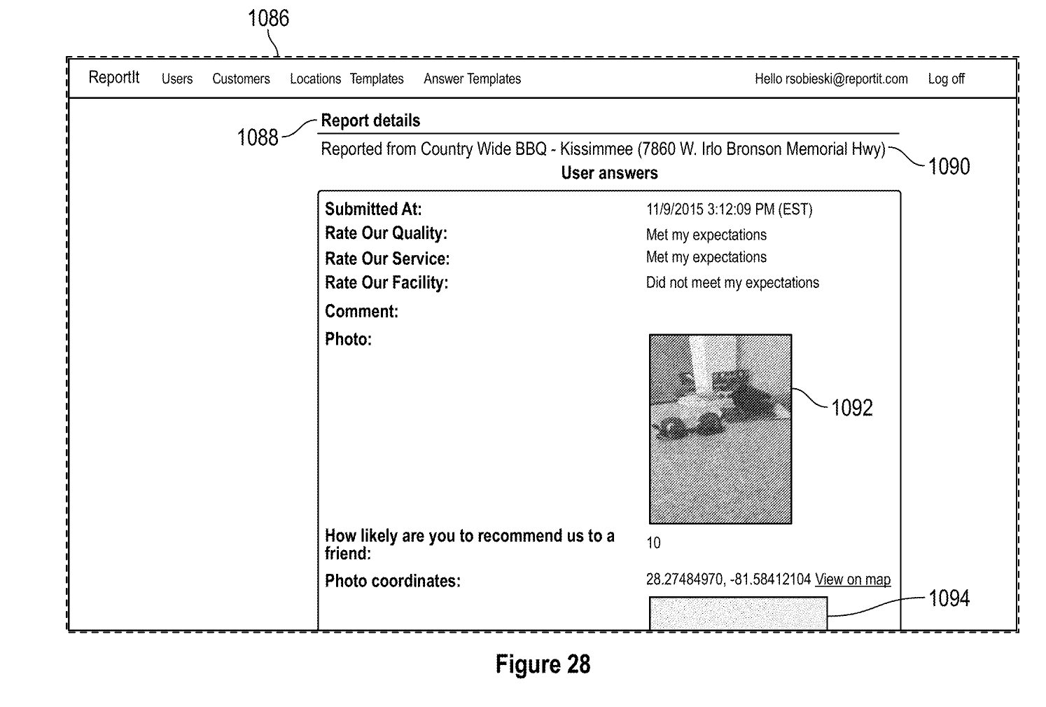

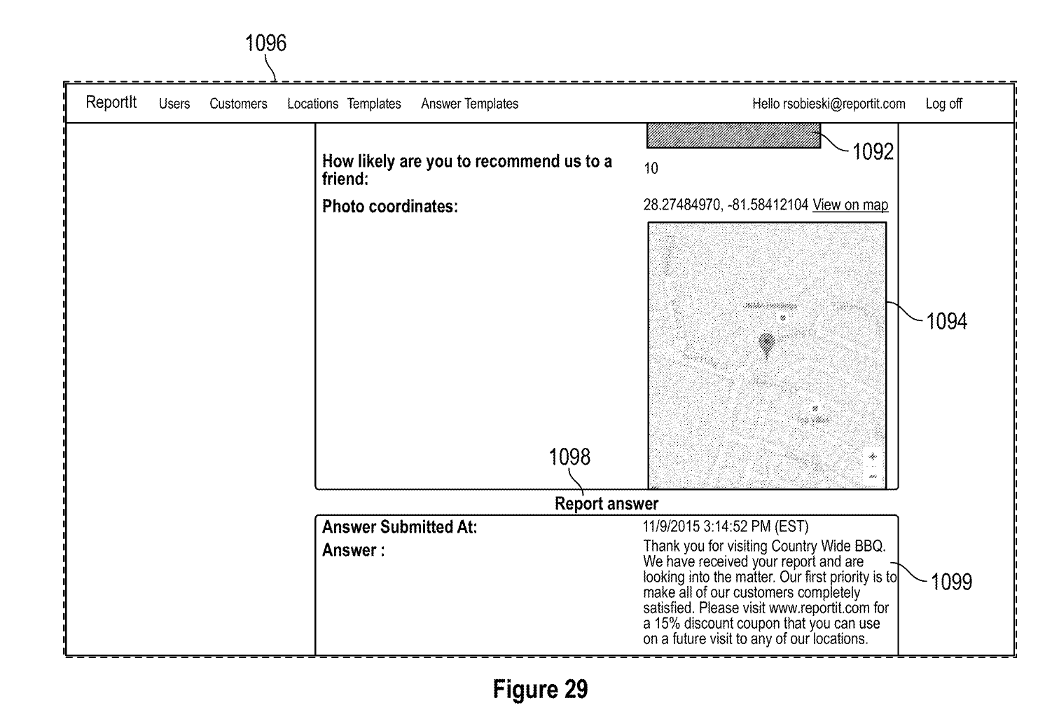

An example embodiment of the reporting service customer participating organization backend tool report details screen 1086, 1096 is presented in FIGS. 28 and 29. The report details example embodiment includes but is not limited to the location information on which the report refers 1090, the report questionnaire answers completed and submitted by the user 1092 accompanied by any comments or photo submitted by the user, and the inclusion of the photo coordinates 1094.

FIG. 29 further presents a continuation of an example embodiment of the reporting service customer participating organization backend tool report details screen 1096. The report detail further includes but is not limited to the location information on which the report refers 1090, the report questionnaire answers completed and submitted by the user 1092, any comments or photo submitted by the user, the inclusion of the photo coordinates 1094 with or without map display, and the customer participating organization's report answer 1098 response in text form 1099 to the submitted report.

It should be understood that the exemplary embodiments of the platform system 101, described herein represent specific implementations. One of the novel characteristics of the platform system 101 is its flexibility, which enables it to be used to facilitate anonymous communication between users and a wide variety of participating organizations, for a wide variety of purposes. The following is a description of the core functions of the platform system 101.

In order to initiate a specific implementation of the platform system 101, the unique code 122 is created, along with at least three associations between the unique code 122 and other data in the platform system 101. At least one template association is created, which causes a specific input template (also referred to herein as a questionnaire or questionnaire template) to be presented to the user via the mobile application when the user selects the unique code 122. A reporting association is created between the unique code 122 and at least one participating organization 108. The reporting association determines which participating organization(s) 108 will be notified of, and have access to, reports 156 generated from the input template associated with that unique code 122. At least one search association is also created, which facilitates the user's ability to locate and select the unique code 122 that is of interest to the user.

As described above in connection with FIG. 6, the search associations can take on a number of forms and provide a great deal of flexibility of usage. In addition, because the platform system 101 is designed to support a large number of participating organizations 108 and input templates, the platform system 101 preferably enables the user to quickly and easily find the desired input template. One type of search association is a location (or group of locations), which would enable the platform system 101 to filter and/or prioritize a list of input templates shown on the user's mobile device based on the location of the mobile device in relation to the location(s) associated with unique code 122. Another type of search association is a machine readable code, such as a QR code or a bar code. This would enable the unique code 122 to be associated with a location or a physical object where that code is displayed. For example, a QR code could be provided on a product. When the QR code is scanned by a mobile device running the application software, the user would be presented with an input template that is tailored for the product associated with the unique code 122. Another possible search association is based on the user's history of use of the application software 116. For example a search association could be created when the user selects a unique code 122 and completes an input template associated with that code.

For a participating organization 108 having more than one location, the system 101 enables multiple input templates to be associated with that participating organization 108. In this type of implementation, each input template could be tailored to the location with which it is associated. This arrangement could be handled by the system 101 by creating a unique code 122 for each location, creating one template association for each unique code 122, and creating a reporting association for each unique code 122 that is directed to that participating organization 108. Alternatively, a single unique code 122 could be created and all of the input templates could be associated with that single unique code 122. The former structure would have the advantage of providing a unique code 122 for each location.

Another novel aspect of the invention is the level of anonymity provided to the user by the platform system 101. Such anonymity is intended to encourage honest and complete communication by the user. When a mobile device 100 installs the application software, the platform system 101 preferably associates that installation of the application software with a unique installation ID of the mobile device 100. In preferred embodiments of the present invention, the operator of the platform system 101 does not capture or use the unique installation ID. Further, unless the user chooses to provide additional identifying information directly to a participating organization 108, the unique installation ID of the mobile device 100 is the only data that may be used by a participating organization to send a push notification to the user, assuming that the user has selected the option to have push notifications sent to them. This association enables identification of the mobile device 100 from which a report 156 has been transmitted and enables follow-up or responsive communications to be routed to the mobile device 100 that sent the report 156, without sacrificing user anonymity. For example, this functionality would enable a participating organization 108 to send a coupon to each user who sends a report 156 providing customer service feedback for a business establishment operated by the participating organization 108. If the user does not select the push notification option, the unique installation ID also remains unavailable to the participating organization 108.

The anonymity provided to the user by the platform system 101 will now be described in detail. The application software 116 has been developed to work on Android, iOS (Apple) and WebMobile Platforms. For all three types of operating system platforms, the inventors have developed a methodology to insure complete anonymity for the user. The software application 116 according to the present invention, when used on a mobile device 100, communicates directly with the server database and does not use SMS or cellular information. Accordingly, the operators of the application software 116 are not given access to the user's phone number or e-mail information. The inventors have developed the following methods to communicate with the mobile device 100.

For Android operating systems: The software application 116 captures an ANDROID_ID. The ANDROID_ID is a 64-bit number that is randomly generated when the user first sets up the mobile device 100 and should remain constant for the lifetime of the user's mobile device 100. The value may change if a factory reset is performed on the mobile device 100. Since the value is random, there is no connection to the mobile device 100 itself, thereby ensuring that the operator of the software application 116 does not have a way to identify the hardware (e.g., specific mobile device 100) that is being used.

For iOS operating systems: The software application 116 generates a random unique ID at the client side upon installation of the software application 116 on the user's mobile device 100. This unique ID is stored in iCloud so that the user can access reports and answers if the software application 116 is deleted but later reinstalled. Since the unique ID is created by the software application 116 and is random, there is no connection to the mobile device 100 itself, thereby ensuring that the operator of the software application 116 does not have a way to identify the hardware (e.g., specific mobile device 100) that is being used.

For WebMobile and Desktop operating systems: WebMobile and Desktop applications are accessed by using interne browser software such as Chrome or Safari. The first time a user accesses the website on which the software application 116 is hosted, the software application 116 generates a unique ID and stores it in the browser's local storage. When the user returns to the website in the future, the website will recognize the user's settings. Since the unique ID is created by the software application 116 and is random, there is no connection to the hardware device itself (e.g., desktop computer or mobile device 100), thereby ensuring that the operator of the software application 116 does not have a way to identify the hardware (e.g., specific mobile device 100) that is being used.

In addition, the software application 116 generates a device token for Android and iOS applications based upon the method outlined above so that push notifications may be provided to the user. If the user agrees to accept push notifications from the software application 116 during initial installation, the device token that is created during installation will be used to send push notifications to the device in the future.

When data associated with an input template is submitted by a user via a mobile device 100, location information is preferably not automatically included in the report 156. Location information may be provided if the user submits a digital photograph or video file and affirmatively consents to the association of location information with that file. Optionally, some input templates could include a location field that auto-populates the present location of the mobile device. For example, an input template for a work-related incident report or a report of suspicious activity to law enforcement could, by default, include one or more pre-populated fields identifying the current location of the mobile device 100.

Although exemplary implementations of the herein described systems and methods have been described in detail above, those skilled in the art will readily appreciate that many additional modifications are possible in the exemplary embodiments without materially departing from the novel teachings and advantages of the herein described systems and methods. Accordingly, these and all such modifications are intended to be included within the scope of the herein described systems and methods. The herein described systems and methods may be better defined by the following exemplary claims.

1. An apparatus adapted to transmit a location-specific or participating organization-specific questionnaire report template to a user of an electronic device, the apparatus comprising instructions stored on non-transitory machine readable media that, when executed, cause at least one server to:
anonymously receive, responsive to an authorization by the user of the electronic device, information sufficient to identify a geographic location of the electronic device;
generate, from server-accessible memory, a list of participating organizations within a geographic area, the geographic area being determined at least in part by the information received from the user relating to the geographic location of the electronic device;
transmit the list of participating organizations within the geographic area to the electronic device of the user for display on the electronic device;
anonymously receive report information from the third party user relating to at least one participating organization of the list of participating organizations;
generate, from server-accessible memory, the location-specific or participating organization-specific questionnaire report template, wherein at least some contents of the location-specific or participating organization-specific questionnaire report template are determined at least in part by the information received from the user relating to the identity of the at least one participating organization; and
transmit the location-specific or participating organization-specific questionnaire report template to the user.

2. The apparatus of claim 1, the apparatus further comprising instructions stored on non-transitory machine readable media that, when executed, cause the at least one server to:
anonymously receive report information from the user relating to the at least one participating organization of the list of participating organizations in response to the location-specific or participating organization-specific questionnaire report template.

3. The apparatus of claim 1, the apparatus further comprising instructions stored on non-transitory machine readable media that, when executed, cause the at least one server to:
receive feedback information from the at least one participating organization in response to the received report information; and
transmit the feedback information to the electronic device of the user.

4. The apparatus of claim 1, the apparatus further comprising instructions stored on non-transitory machine readable media that, when executed, cause the at least one server to:
generate, from server-accessible memory, the list of participating organizations within the geographic area based on a geofenced area or political unit.

5. The apparatus of claim 4, the apparatus further comprising instructions stored on non-transitory machine readable media that, when executed, cause the at least one server to define the geofenced area based on a custom polygon tool.

6. The apparatus of claim 4, the apparatus further comprising instructions stored on non-transitory machine readable media that, when executed, cause the at least one server to define the geofenced area based on a predefined circular region.

7. The apparatus of claim 2, the apparatus further comprising instructions stored on non-transitory machine readable media that, when executed, cause the at least one server to anonymously receive the report information from the user relating to the at least one participating organization, wherein in response to an instruction provided by the user, the apparatus collects weather data relating to the geographic area and includes the weather data in the report information.

8. A method of operating at least one server, the method comprising:
anonymously receiving geolocation information from a third party user, the geolocation information being dependent on a then-current location of an electronic device owned by the third party user;
generating from server-accessible memory a list of participating organizations within a geographic area, the geographic area being determined at least in part by the geolocation information received from the electronic device of the third party user;
transmitting the list of participating organizations within the geographic area to the electronic device of the third party user for display thereon; and
anonymously receiving report information from the third party user relating to at least one participating organization of the list of participating organizations.

9. The method of claim 8, further comprising, prior to the step of anonymously receiving report information from the third party user:
anonymously receiving information from the third party user relating to the identity of the at least one participating organization; and
transmitting to the third party user a location-specific or participating organization-specific questionnaire report template, wherein at least some contents of the location-specific or participating organization-specific questionnaire report template are determined at least in part by the information received from the third party user relating to the identity of the at least one participating organization.

10. The method of claim 8, further comprising transmitting the received report information to the at least one participating organization.

11. The method of claim 10, further comprising:
receiving feedback information from the at least one participating organization in response to the received report information; and
transmitting the feedback information to the electronic device of the third party user.

12. The method of claim 8, wherein the step of anonymously receiving report information from the third party user relating to the at least one participating organization comprises receiving a photograph or video from the third party user, the photograph or video relating to the at least one participating organization.

13. The method of claim 8, wherein the step of anonymously receiving report information from the third party user relating to the at least one participating organization comprises receiving a comment or question relating to the at least one participating organization.

14. The method of claim 8, wherein the step of generating from server-accessible memory a list of participating organizations within a geographic area further comprises determining the geographic area based on a geofenced area or political unit.

15. The method of claim 14, wherein the step of determining the geographic area based on a geofenced area or political unit comprises defining the geofenced area based on a custom polygon tool.

16. The method of claim 14, wherein the step of determining the geographic area based on a geofenced area or political unit comprises defining the geofenced area based on a predefined circular region.

17. The method of claim 8, wherein the step of anonymously receiving report information from the third party user relating to at least one participating organization of the list of participating organizations further comprises collecting weather data relating to the geographic area and including the weather data in the report information.
